(19) United States
(12) Patent Application Publication
(10) Pub. No.: US 2023/0413268 A1
(43) Pub. Date: Dec. 21, 2023

(54) SHORT FEEDBACK PROCEDURE FOR SIGNALLING MULTIPLE TECHNOLOGIES IN WIRELESS NETWORKS

(71) Applicant: CANON KABUSHIKI KAISHA, Tokyo (JP)

(72) Inventors: Pascal VIGER, JANZE (FR); Stéphane BARON, LE RHEU (FR); Patrice NEZOU, LIFFRE (FR)

(21) Appl. No.: 18/251,524

(22) PCT Filed: Nov. 5, 2021
(86) PCT No.: PCT/EP2021/080713

§ 371 Date: May 2, 2023

(30) Foreign Application Priority Data
Nov. 6, 2020 (GB) 2017596.4

(51) Int. Cl. H04W 72/20

(52) U.S. Cl. CPC H04W 72/20; H04W 84/12

(57) ABSTRACT

A NFRP trigger frame schedules multiple RU tone sets for wireless stations to declare resource needs. The AP schedules data RUs in MU UL transmissions for the responding stations. Stations relying on different technologies for scheduling the data RUs can coexist. The AP needs to know precisely which responding station accepts which technology in order to efficiently schedule them with subsequent RUs using the appropriate RU scheduling technology. The AP signals various technologies in the NFRP trigger frame, using a bitmap where each bit corresponds to a possible technology. A polled station responds when it is compatible with a signaled technology and indicates resource needs and the technologies supported. Groups of tones corresponding to respective compatible signaled technologies may be activated within the RU tone set used for the NDP feedback report response. The AP thus schedules the various responding stations using simultaneous or consecutive subsequent MU UL transmissions.

### FIELD OF THE INVENTION

The present invention generally relates to wireless communications.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE®) provides a great number of mechanisms for wireless communications between stations.

Inter alia, the 802.11 family provides multi-user (MU) schemes to allow a single access point (AP) to schedule MU transmissions, i.e. multiple simultaneous transmissions to or from non-AP stations or “nodes”, in the wireless network. This approach increases bandwidth and decreases latency requirements compared to original 802.11 networks.

MU downlink (DL) transmission is allowed where the AP performs multiple simultaneous elementary transmissions, over so-called resource units (RUs), to various non-AP stations. As an example, the resource units split a communication channel of the wireless network in the frequency domain, based for instance on Orthogonal Frequency Division Multiple Access (OFDMA) technique.

MU uplink (UL) transmissions are also allowed that are triggered by the AP. Various non-AP stations can simultaneously transmit to the AP over the resource units forming the MU UL transmission. To control the MU UL transmission by the non-AP stations, the AP sends a control frame, known as a Trigger Frame (TF), which defines the plurality of resource units for the non-AP stations.

Various variants of trigger frames exist depending on the nature of information the non-AP stations can provide in response. The trigger frames are defined in section 9.3.1.22 of the 802.11ax standard (D8.0).

The main variant is the Basic trigger frame to trigger a MU UL transmission for the non-AP stations to send any data they wish.

Some RUs of the MU UL transmission may be allocated by the Basic trigger frame to specific non-AP stations using 16-bit Association IDentifiers (AIDs) assigned to them upon registration to the AP (so-called scheduled RUs).

Others RUs (known as random RUs) are available to non-AP stations, registered or not to the AP, using a contention-based access scheme. Only three types of trigger frames are known that provide such random-access to RUs, namely the Basic Trigger frame, the BQRP Trigger frame and the BSRP Trigger frame. This scheme is known as UL OFDMA-based random-access (UORA) scheme.

UORA is useful for wireless networks because it provides opportunities for the non-AP stations to transmit, without the AP having polled them to know their needs for transmission. However, it suffers from various drawbacks.

It suffers from a low maximum efficiency of 37% (successfully used random RUs) to be compared to 37% of unused random RUs and 26% of random RUs with collisions.

The lost random RUs (either unused or collided) occur on large transmission durations (because transmitting non-AP stations have usually substantial amounts of data to transmit during UORA, hence the MU UL transmission is provided for a large transmission duration). This substantially decreases network efficiency.

A variant trigger frame to the Basic trigger frame is the Null-Data-Packet (NDP) Feedback Report Poll (NFRP) trigger frame implementing the so-called Null-Data-Packet (NDP) Feedback Report procedure. This procedure allows the AP to collect feedback that is not channel sounding from multiple non-AP stations in a more efficient manner, because shorter in time, than with the Basic trigger frame.

The AP sends a NFRP trigger frame to solicit NDP feedback report responses from many non-AP stations that are identified by a range of scheduled AIDs in the NFRP Trigger frame. The NDP feedback report response from a non-AP station is a HE trigger-based (TB) feedback NDP. It announces whether the non-AP station needs network resources to send data.

The procedure is short compared to the duration of an UL transmission triggered by the Basic trigger frame, mainly because the NDP in response is short in time. It also has a low and stable latency compared to conventional “Carrier Sense Multiple Access with Collision Avoidance” CSMA-CA mechanisms when used in dense environments.

Some evolutions of the MU schemes are currently under consideration by the IEEE 802.11 working group as a main objective to issue the next major 802.11 release, known as 802.11 be or EHT for “Extremely High Throughput”.

In particular, trends would make 802.11be stations supporting new communication capabilities that will not be retrofitted to the legacy 802.11ax stations. As an example, MU communications will optionally be punctured in frequency or the operating frequency band of 802.11be stations will be larger (320 Mhz instead of 180 Mhz). As a result, a new Trigger Frame (TF) format, even more complex and thus not fully readable by the 802.11ax stations, is liable to be designed for the 802.11 be standard to define a larger and different plurality of resource units for the 802.11be non-AP stations. Furthermore, for the time being, it is not sure whether all 802.11 be stations will support all operating modes for this new TF format.

In this context, the existing NDP Feedback Report procedure is not satisfying.

Indeed, while the NFRP trigger frame addresses a limited set of non-AP stations with consecutive AIDs (usually 18 or 36 for a 20 Mhz wide operating band), those non-AP stations may rely on various 802.11 releases or technologies: for instance, some non-AP stations may be 802.11 be stations while others may be 802.11ax stations. In addition, some AIDs may have been released when the corresponding non-AP stations leave the BSS (managed by the AP) during the lifetime of the network. In other words, the conventional NFRP-based NDP Feedback Report procedure does not consider scalability towards next versions of the 802.11 standard.

### SUMMARY OF INVENTION

The present invention seeks to overcome some of the foregoing concerns by upgrading the conventional NFRP mechanism to address various technologies embedded in the stations.

In this respect, the present invention proposes a communication method in a wireless network, comprising the following steps at a polled station:
receiving, from a polling station (preferably an access point, AP, but not necessarily, for instance in ad hoc networks), a null data packet, NDP, feedback report poll, NFRP, trigger frame reserving a plurality of resource unit, RU, tone sets for NDP feedback report responses by polled stations, the NFRP trigger frame signaling one or more technologies from amongst a plurality of technologies, the technologies being available at the polling station to provide subsequent transmission resources to the polled stations. Therefore, the various technologies rely on various respective resources-providing mechanisms,
determining at least one technology compatible with the polled station from amongst the one or more signaled technologies, and
sending a NDP feedback report response in relation to the compatible technology or technologies (e.g. the polled station needs resources and accepts they are provided using this technology in a subsequent transmission opportunity), on a selected responding RU tone set.

Conversely, the invention also proposes a communication method in a wireless network, comprising the following steps at a polling station (preferably an access point, AP, but not necessarily, for instance in ad hoc networks):
sending, to polled stations, a null data packet, NDP, feedback report poll, NFRP, trigger frame reserving a plurality of resource unit, RU, tone sets for NDP feedback report responses by polled stations, the NFRP trigger frame signaling one or more technologies from amongst a plurality of technologies, the technologies being available at the polling station to provide subsequent transmission resources to the polled stations,
receiving, from at least one responding station on a responding RU tone set, a NDP feedback report response in relation to at least one signaled technology.

The polling station, e.g. the AP, can then declare the various technologies (i.e. resource-providing mechanisms) it supports and/or it wishes to implement and, based on the NDP responses from the polled stations, be aware of which station supporting which technology needs resources. Consequently, the polling station can efficiently provide (or schedule) new transmission resources or opportunities to the polled stations using adapted (i.e. compatible with the stations) scheduling technologies. Various technologies may for example correspond to various releases of 802.11, for instance 802.11 ax triggering frames to be opposed to 802.11be (or any future release) triggering frames.

Correlatively, the invention also provides a communication device, either the polling station (e.g. an AP) or a polled station, comprising at least one microprocessor configured for carrying out the steps of any of the above methods.

Optional features of embodiments of the invention are defined in the appended claims. Some of these features are explained here below with reference to a method, while they can be transposed into device features.

Advantageously, the polling station may provide, using one of the signaled technologies, subsequent transmission resources to responding stations of feedback report responses related to the same signaled technology. Indeed, thanks to the responses related to each of the signaled technologies, the polling station (e.g. AP) knows which responding polled stations are compatible with a given technology. It can then take a decision to provide for instance data RUs to these polled stations using the given technology. This avoids having some responding polled stations not correctly detecting the subsequent transmission resources due to incompatible scheduling technology, hence loosing data RUs. A data RU may convey user data and/or control data.

Such a transmission resource (i.e. opportunity to transmit) may be for instance a resource unit RU in a triggered MU UL transmission.

In some embodiments, the polling station may, simultaneously or consecutively to the subsequent transmission resources, provide, using another signaled technology, other subsequent transmission resources over a distinct channel to responding stations of feedback report responses related to the same other signaled technology. In that way, the polling station (e.g. AP) efficiently manages polled stations relying on different technologies, e.g. compliant with different versions of the 802.11 standard.

In particular embodiments, the NFRP trigger frame signals (e.g. using reserved bit B63 of the Common Info field of the frame) whether the subsequent transmission resources and the other subsequent transmission resources are simultaneous or consecutive. This helps the polled stations to know in advance which scheduling scheme will be used by the polling station to provide the subsequent transmission resources (e.g. data RUs for the responding stations).

From the polled station perspective, the method may further comprise, receiving, using one compatible technology, a subsequent transmission resource from the polling station. This subsequent transmission resource may be a mere data RU in a MU UL transmission scheme scheduled by an AP using a trigger frame compliant with said compatible technology. The polled station can then send data using this subsequent transmission resource.

In some embodiments, the polled station may, consecutively to the subsequent transmission resource, receive, using another compatible technology, another subsequent transmission resource (e.g. a new RU in a MU UL transmission) from the polling station. The polled station is thus offered multiple subsequent resources to transmit data.

Indeed, the polled station may have signaled its capabilities for various technologies. In other words, the NDP feedback report response may be provided in relation to two or more signaled (thus compatible) technologies.

Preferably, the polled stations are not allowed to respond to each and any NFRP trigger frame, because too many stations may populate the network. The polled station may thus further determine, based on an association identifier, AID, field included in the received NFRP trigger frame, that the polled station is allowed to respond to the NFRP trigger frame over a selected responding RU tone set.

As described below, the NFRP trigger frame may specify a range of association identifiers, AIDs, designating polled stations allowed to send NDP feedback report responses on the RU tone sets. The polled station thus merely checks whether its AID (obtained from the AP upon registration) falls within the range.

In a variant, an association identifier, AID, field in the NFRP trigger frame may include a predefined AID value defining a random access for the polled stations to the plurality of RU tone sets. In that case, the polled station is directly allowed to access, randomly or using a random-based counter, one of the RU tone sets to respond.

In variants related to a multi-AP mechanism where neighboring APs may share resources, the NFRP trigger frame may specify a broadcast Basic Service Set Identifier, BSSID, or a multi-AP BSSID identifying a group of multiple access points, APs. In that case, the polled station, that is an AP, detects the broadcast BSSID or determines it belongs to the multi-AP group identified by the multi-AP BSSID. This is to declare, as an AP, that it needs resources (for its managed BSS for instance).

In some embodiments, the one or more technologies are signaled in a User Info field of the NFRP trigger frame. Note that usually there is only a single User Info field in a NFRP trigger frame, making it possible for the polled stations to easily retrieve the signaled technologies. In particular, the one or more technologies may be signaled within the 9-bit reserved subfield of the User Info field defined in 802.11ax D8.0 standard, section 9.3.1.22.9. The NFRP trigger frame thus advantageously keeps the 802.11ax format, hence remains readable by 802.11ax stations.

In alternative embodiments, the one or more technologies are signaled in a Trigger Dependent Common Info field of the NFRP trigger frame. This field is defined from bit B64 in the Common Info field of the NFRP trigger frame according to 802.11ax D8.0 standard, section 9.3.1.22.1. Again, compatibility of the NFRP trigger frame with 802.11ax stations is kept.

In some embodiments, the signaling of the one or more technologies includes setting a respective bit of a bitmap to an enabled value (e.g. bit set to 1) for each of the signaled technologies, where the bitmap has a plurality of bits corresponding to the plurality of technologies respectively. The bitmap-bases scheme is advantageously easily scalable for future additional technologies to schedule transmission resources.

Of course, other mechanisms than a bitmap may be used: for instance, different values in a field to signal different sets of technologies.

In some embodiments, the signaling of the one or more technologies is announced, in the NFRP trigger frame, through a Feedback Type subfield (as defined in 802.11ax D8.0 standard, section 9.3.1.22.9) set to a value different from 0 in the NFRP trigger frame. This makes it possible to keep the NFRP trigger frame compliant with an 802.11ax trigger frame format: the 802.11ax station (unable to deal with the signaling of the technologies) will discard the NFRP trigger frame as soon as the Feedback Type subfield takes an unknown value (i.e. different from the sole known value in 802.11ax standard: value 0).

In some embodiments, the NFRP trigger frame further signals a type of traffic data in relation to at least one signaled technology. For instance, the type of traffic may be low latency reliable service, LLRS, data targeted by the 802.11 be standard. LLRSs are services provided to a higher layer traffic stream that prioritize and deliver MSDUs (data units) within a worst-case latency budget with a given reliability/packet delivery ratio (PDR) and low jitter. Examples of such latency sensitive applications include online gaming, real-time video streaming, virtual reality, drone or robot remote controlling.

The signaling of a traffic type may be made at technology level (i.e. one traffic type per signaled technology) or be made once for all the signaled technologies (i.e. a single traffic type for all the signaled technologies) or be made by subgroups of signaled technologies.

In some embodiments, the plurality of technologies available at the polling station (e.g. an AP) includes one or more of:
using a Basic trigger frame according to the 802.11ax D8.0 standard (in the meaning of section 9.3.1.22),
using a Basic trigger frame only recognized by 802.11 be or upper version stations,
using multi-AP technology to provide transmission resources to other APs.

A single multi-technology polling station (e.g. an AP) can thus be used to efficiently manage an 802.11 wireless network.

In some embodiments, the number of tones forming each RU tone set depends on the number of signaled technologies. This makes it possible to dynamically adapt the number of polled stations allowed to respond to the NFRP trigger frame, depending on how many technologies the polling station wishes to receive NDP feedback responses.

In some embodiments, each RU tone set is made of a plurality of groups of tones, each group being associated with a respective one of the signaled technologies. In that way, the polled stations can easily provide their NDP feedback response per each signaled technology (by activating or not the respective group of tones).

In particular embodiments, a NDP feedback report response related to a signaled technology includes conveying energy on the respective group of tones within the responding RU tone set. This reports the responding station requires resources to be scheduled using the related technology. Energy may be conveyed over two or more groups of tones in the responding RU tone set, when the responding station is compliant with two or more signaled technologies to obtain subsequent transmission resources, such as data RUs in MU UL transmissions.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Further advantages of the present invention will become apparent to those skilled in the art upon examination of the drawings and detailed description. Embodiments of the invention will now be described, by way of example only, and with reference to the following drawings.

FIG. 1 illustrates a network environment in which embodiments of the invention may be implemented;

FIGS. 2a, 2b illustrate two usages of trigger frames for short feedback procedure and subsequent UL MU procedure;

FIG. 3a illustrates the format of a trigger frame;

FIG. 3b illustrates the format of a NDP Feedback Report response;

FIG. 4 shows a schematic representation a communication device in accordance with embodiments of the present invention;

FIG. 5 shows a schematic representation of a wireless communication device in accordance with embodiments of the present invention;

FIGS. 6a and 6b illustrate two scenarios adapting the one of FIG. 2a to embodiments of the present invention;

FIGS. 6c and 6d illustrate, using flowcharts, general steps for the scenarios of FIGS. 6a and 6b at a polling station and a polled station, respectively, according to embodiments of the present invention;

FIG. 7 illustrate a scenario adapting the one of FIG. 2b to embodiments of the present invention;

FIGS. 7a and 7b illustrate, using flowcharts, general steps for the scenario of FIG. 7 at a polling station and a polled station, respectively, according to embodiments of the present invention; and

FIG. 8 illustrates the format of a User Info field of a NFRP trigger frame according to embodiments of the invention.

### DETAILED DESCRIPTION

The invention will now be described by means of specific non-limiting exemplary embodiments and by reference to the figures.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to simultaneously transmit data belonging to multiple user terminals, i.e. wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP) or not (so-called non-AP station or STA).

An AP may comprise, be implemented as, or known as a Node B, Radio Network Controller (“RNC”), evolved Node B (eNB), 5G Next generation base station (gNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

An AP manages a set of stations that together organize their accesses to the wireless medium for communication purposes. The stations (including the AP) form a service set, here below referred to as basic service set, BSS (although other terminology can be used). A same physical station acting as an access point may manage two or more BSS (and thus corresponding WLANs): each BSS is thus uniquely identified by a specific basic service set identification, BSSID and managed by a separate virtual AP implemented in the physical AP.

The invention relates to the NDP feedback report procedure where a NFRP trigger frame schedules multiple RU tone sets for stations of a wireless network to declare resource needs to the AP. The AP may then schedule data RUs in MU UL transmissions for the stations responding they need transmission resources. Due to evolutions of the wireless standards, stations relying on different technologies for scheduling the data RUs can coexist within the same wireless network. The AP needs to know precisely which responding station accepts which technology in order to efficiently schedule them with subsequent RUs using the appropriate RU scheduling technology. The AP may signal the various technologies in the NFRP trigger frame, using a bitmap where each bit corresponds to a possible technology. A polled station targeted by the NFRP trigger frame may then decide to respond when it is compatible with a signaled technology. The NDP feedback report response may further indicate resource needs and the technologies supported. For instance, groups of tones corresponding to respective compatible signaled technologies may be activated within the RU tone set used for the NDP feedback report response. The AP can thus efficiently schedule the various responding stations using simultaneous or consecutive subsequent MU UL transmissions.

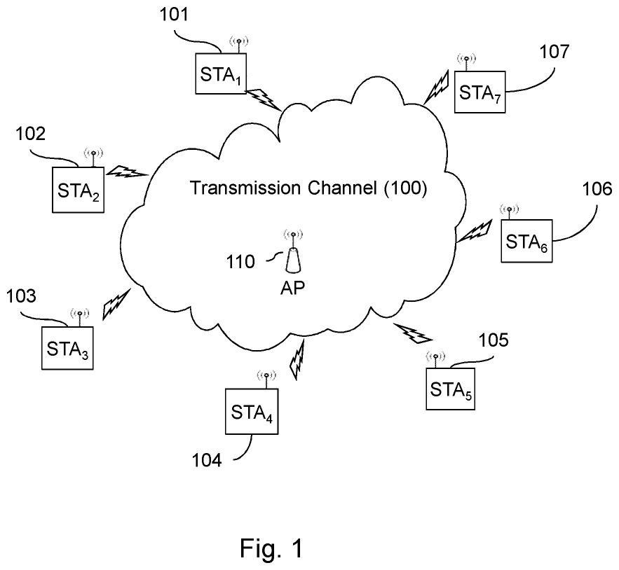

FIG. 1 illustrates a communication system in which several communication stations (or “nodes”) 101-107, 110 exchange data frames over a radio transmission channel 100 of a wireless local area network (WLAN), under the management of a central station, or access point (AP) 110, also seen as a station of the network. The radio transmission channel 100 is defined by an operating frequency band constituted by a single channel or a plurality of channels forming a composite channel.

The communication system may be compliant with 802.11 standards.

In the following, the word “station” refers to any kind of station. The wording “access point station”, or in short “access point” (AP), refers to the station playing the role of access point 110. The wording “non-access point station”, or in short “non-AP station”, or client station (STA) refers to the other stations 101-107.

In the following, the terms HE STA and HE AP refer respectively to an 802.11ax non-AP STA and an 802.11ax AP. The 802.11ax standard is also known as High Efficiency (HE).

The terms EHT STA and EHT AP refer respectively to an 802.11 be non-AP STA and an 802.11 be AP. The 802.11 be standard is also known as Extremely High Throughput (EHT).

Access to the shared radio medium to send data frames is primarily based on the CSMA/CA technique, for sensing the carrier and avoiding collision by separating concurrent transmissions in space and time.

Carrier sensing in CSMA/CA is performed by both physical and virtual mechanisms. Virtual carrier sensing is achieved by transmitting control frames to reserve the medium prior to transmission of data frames.

Next, a source or transmitting station, including the AP, first attempts through the physical mechanism, to sense a medium that has been idle for at least one DIFS (standing for DCF InterFrame Spacing) time period, before transmitting data frames.

However, if it is sensed that the shared radio medium is busy during the DIFS period, the source station continues to wait until the radio medium becomes idle.

The wireless communication system of FIG. 1 comprises physical access point 110 configured to manage the WLAN BSS (Basic Service Set), i.e. a group of non-AP stations which have previously registered to the AP.

Thus, each communication station 101-107 registers to a central station or access point (AP) 110 during an association procedure where the AP assigns a specific Association IDentifier (AID) to the requesting non-AP station. For example, the AID, e.g. a 16-bit value uniquely identifying the non-AP station, is used to identify the stations in the frame exchanged. The AP 110 and the associated non-AP stations 101-107 may represent a basic service set (BSS) or an extended service set (ESS).

Once the BSS is established, the Access Point can bridge traffic inside the BSS or from other networks (e.g. wired networks) into the BSS (or vice and versa). Thus, the non-AP stations of the BSS should talk to the AP only, which is in charge of relaying data frames if the data frames are targeted to another station of the BSS.

A physical access point 110 may be configured to manage two or more WLANs (or BSSs), i.e. two or more groups of station. Each BSS is uniquely identified by a specific basic service set identifier, BSSID, and managed by a virtual AP implemented in the physical AP. A MAC address of the virtual AP is used as BSSID. Generally, the MAC addresses for the virtual APs are generated based on (or “derive from”) a base MAC address specific to the physical access point, usually the base 48-bit MAC address of AP 110.

Within the context of a multiple BSSID set at a single physical AP, one virtual AP is referred to as the ‘transmitted BSSID’ (only one per set) if the virtual AP emits beacon frames. Other BSSIDs (or virtual APs) belonging to the set is a ‘nontransmitted BSSID’. The beacon frame includes the basic profiles and each profile elements that are mandatory for the nontransmitted BSSID. A BSSID Index is a value that identifies the nontransmitted BSSID, where value is a nonzero.

To access the medium, any station, including the AP, starts counting down a backoff counter designed to expire after a number of timeslots when the medium is sensed as idle. The backoff counter is chosen randomly in a so-called contention window [0, CW], where CW is an integer. This backoff mechanism or procedure, also referred to as Distributed Coordination Function (DCF) contention-based channel access scheme, is the basis of the collision avoidance mechanism that defers the transmission time for a random interval, thus reducing the probability of collisions on the shared channel. After the backoff time expires (i.e. the backoff counter reaches zero), the station may send data or control frames if the medium is still idle.

Conventional single-user transmission can occur on at least a primary 20 MHz channel (used for contention) and some secondary 20 Mhz channels: The resulting bandwidth of a composite channel may be e.g. 20 MHz, 40 MHz, 80 MHz, 80+80 MHz, or 160+160 MHz, or 320 MHz. The channels may include one or more subcarriers or tones, for instance a 20 MHz channel is made of 242 tones.

Management of quality of service (QoS) has been introduced at station level in the wireless networks, through well-known EDCA mechanism defined in the IEEE 802.11e standard. The 802.11ax standard seeks to enhance efficiency and usage of the wireless channel for dense environments.

In this perspective, multi-user (MU) transmission features have been considered that allow multiple simultaneous transmissions to/from different non-AP stations in both downlink (DL) and uplink (UL) directions from/to the access point. In the uplink, multi-user transmissions can be used to mitigate the collision probability by allowing multiple non-AP stations to simultaneously transmit to the AP.

To actually perform such multi-user transmission, it has been proposed to split a channel into at least one subchannel, but preferably a plurality of sub-channels (elementary sub-channels), also referred to as sub-carriers or resource units (RUs) or “traffic channels”, that are shared in the frequency domain by multiple users, based for instance on Orthogonal Frequency Division Multiple Access (OFDMA) technique. In some embodiments, the bandwidth of the RUs may be based on a number of active data subcarriers. In some embodiments, the bandwidth of the RUs is based on 26, 52, 106, 242 (a whole 20 MHz channel), 484 (40 MHz channel), 996 (80 MHz channel), or 2×996 (80+80 Mhz or 160 Mhz channel) active data subcarriers or tones.

While the MU DL transmission is fully managed by the AP, the MU UL transmission requires the AP sends a control frame to the non-AP station to trigger the simultaneous MU UL transmissions from the non-AP stations. Such control frame is known as a Trigger Frame (TF), various variants of which exist depending on the usage of the MU UL sub-carriers desired by the AP.

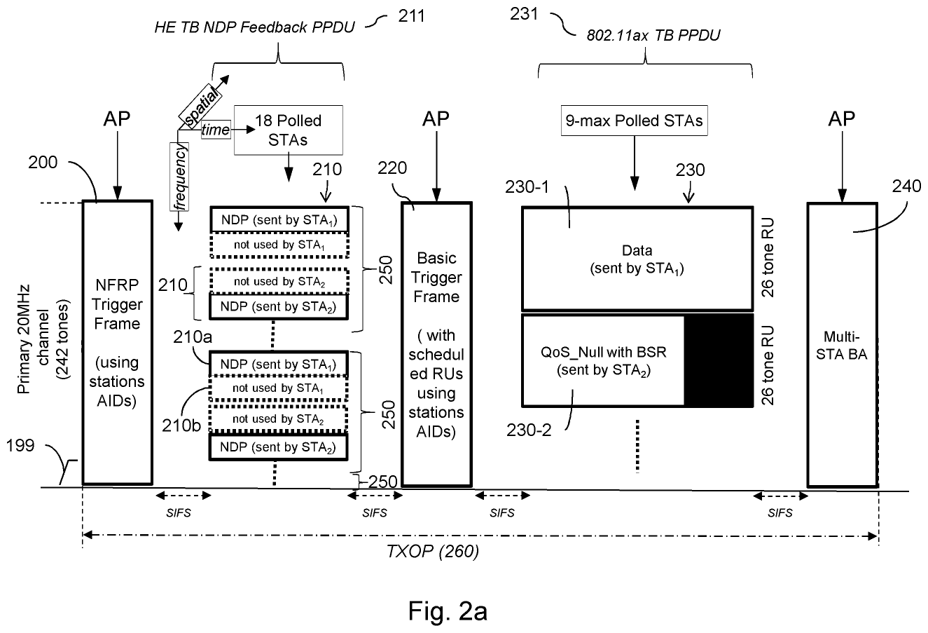

FIGS. 2a, 2b illustrate two usages of trigger frames for short feedback procedure and subsequent UL MU procedure.

In the exemplary embodiment of FIG. 2a, a short feedback report procedure according to 802.11ax (as described in section “26.5.7 NDP feedback report procedure” of Draft D8.0 of IEEE 802.11ax) is shown followed by an UL MU operation (as described in section “26.5.2 UL MU operation” of Draft D8.0 of IEEE802.11ax) based on the results of the short feedback report procedure.

The NDP feedback report procedure allows the AP 110 to collect feedback that is not channel sounding from multiple non-AP STAs 101-107. The AP sends an NFRP Trigger frame to solicit NDP feedback report responses from many non-AP STAs that are identified by a range of scheduled AIDs in the NFRP Trigger frame. A non-AP STA uses the information carried in the NFRP Trigger frame to know whether it is scheduled, and in the affirmative, it may send a NDP feedback report response, usually a HE TB feedback NDP.

Next, based on the received NDP feedback report responses, the AP knows which non-AP STAs requires transmission resources (e.g. data RUs) and may then schedule an UL MU operation to provide data RUs to one or more responding non-AP STAs for simultaneous transmissions.

The example shown considers a single 20 MHz channel. Of course, the bandwidth of the composite channel and the number of RUs splitting a 20 MHz channel may be different from those depicted in the Figure.

In details, at step 199, the AP 110 accesses the wireless medium. For example, the AP performs a contention-based method (which may include a clear channel assessment and an EDCA backoff) to acquire access to the wireless medium.

Upon accessing the medium, the AP 110 polls non-AP STAs to know their needs for transmission. To do so, it sends NFRP trigger frame 200 which is a specific trigger frame. It identifies non-AP STAs by a range of scheduled AIDs.

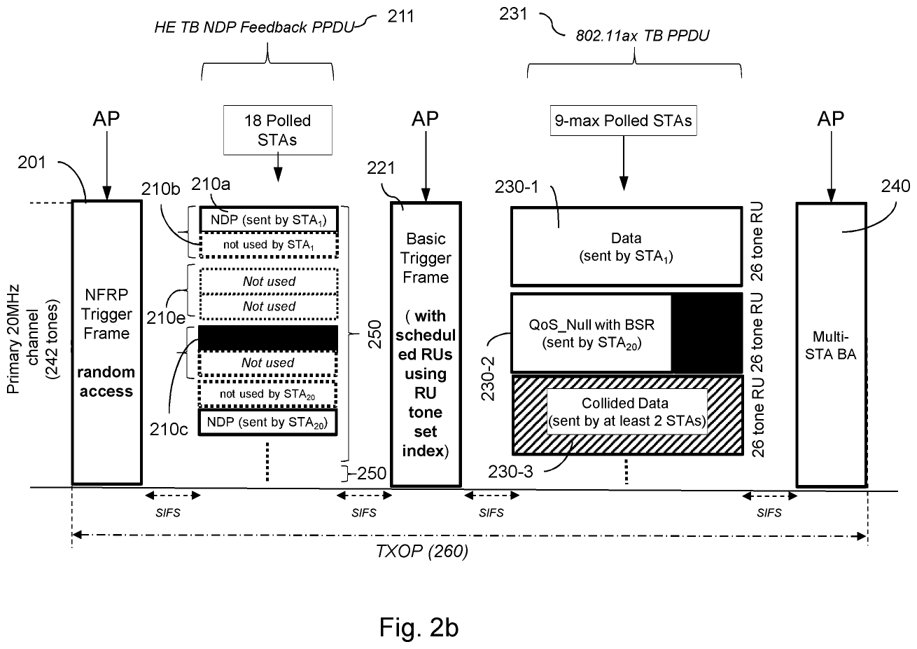

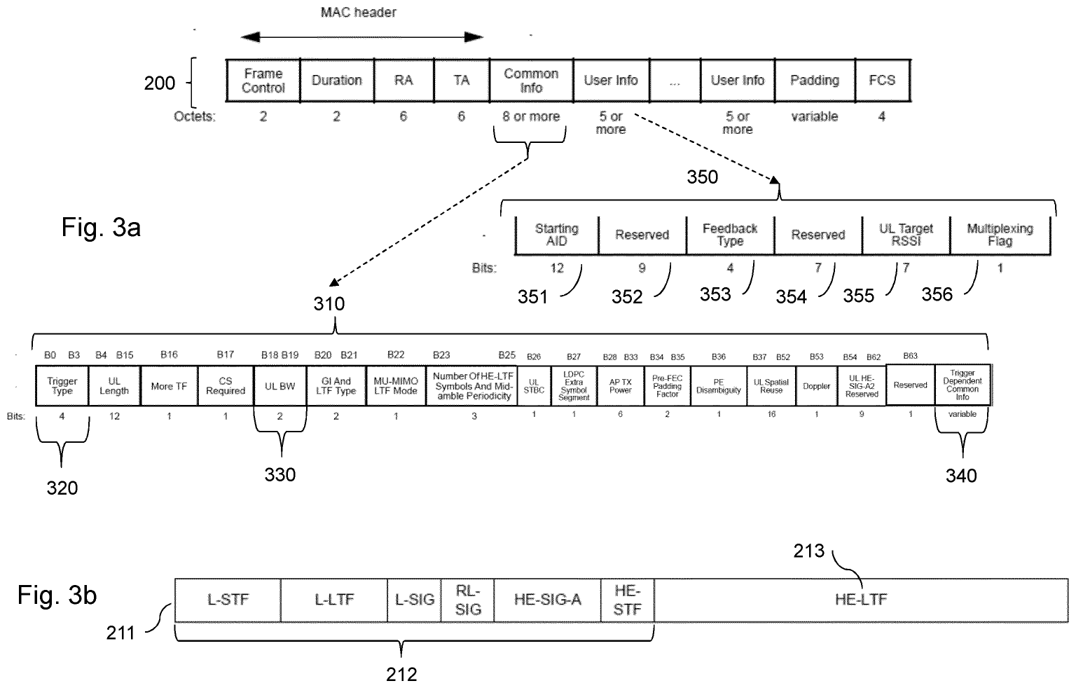

With reference to FIG. 3a, like each and every 802.11ax trigger frame, NFRP trigger frame 200 comprises:
a frame header with a standardized “Frame Control” field, a standardized “Duration” field, an “RA” field set to a broadcast MAC address, and a “TA” field set to a MAC address of the AP transmitting the trigger frame,
a “Common Info” field 310,
one or more “User Info” fields 350, and
padding and FCS fields.

The “Common Info” field 310 comprises a “Trigger Type” subfield 320 which specifies the type of the trigger frame. For instance, NFRP trigger frame 200 is signaled by a value 7 in the “Trigger Type” subfield 320 (a Basic trigger frame is for instance signaled by value 0). It also comprises a 2-bit “UL BW” field 330 specifying the bandwidth of the channel considered, e.g. BW=0 to define a 20 MHz bandwidth, BW=1 for a 40 MHz bandwidth, BW=2 for an 80 MHz bandwidth, BW=3 for an 80+80 MHz or 160 MHz bandwidth (see Table 9-31c of the D8.0 version of 802.11ax). It ends by a Trigger Dependent Common Info subfield 340 of variable length whose content depends on the “Trigger Type” subfield 320. The other fields shown are of less importance for the present invention.

Specific to the trigger frame of NFRP type, a single “User Info” field 350 is provided that comprises a 12-bit Starting AID field 351, a first reserved 9-bit portion 352, a 4-bit feedback type field 353, a second reserved 7-bit portion 354, a 7-bit UL Target RSSI field 355 and a 1-bit multiplexing flag field 356.

The Starting AID comprises the AID starting the range of AIDs targeted by the NFRP trigger frame 200, i.e. scheduled to respond to the poll. The range size or width N_{STA} is defined by the “UL BW” field 330 together with the 1-bit multiplexing flag 356, using the following formula

N_{STA}=18×2^{BW}×(MultiplexingFlag+1).

For instance, when the MultiplexingFlag is set to 0 (no MIMO), 18 non-AP STAs are polled to answer with a NDP feedback report response, per 20 MHz operating channel. When the MultiplexingFlag is set to 1, 36 non-AP STAs are polled per 20 MHz operating channel. It may be noted that some AIDs in the 18 or 36-wide range may not be currently assigned to a non-AP STA, thus reducing the efficiency of the NDP feedback report procedure.

The multiplexing flag 356 defines whether spatiality (MIMO) is provided: the flag indicates the number (minus 1) of non-AP STAs that are multiplexed on the same set of tones in the same RU.

The “feedback type” field 353 indicates a type of feedback that is being polled by the AP. For the time being, 802.11ax D8.0 only defines a feedback type equal to 0 that is a resource request. The corresponding polling thus seeks to know whether the responding non-AP STAs 101-107 are requesting UL resources to transmit PPDUs to the AP 110.

Back to FIG. 2a, the NFRP trigger frame 200 is sent over a 20 MHz primary channel. As well known, the NFRP trigger frame 200 may also be duplicated over other 20 MHz channel composing an extended channel such as 40 MHz, 80 MHz or larger bands. This advantageously extends the number of polled stations. By sending NFRP trigger frame 200, the AP reserves a transmission opportunity 260 (TXOP) corresponding to the duration specified inside the NFRP trigger frame.

If the NFRP trigger frame is sent over an overall width larger than the primary 20 MHz channel, the 802.11ax standard envisages that the NFRP trigger frame is duplicated (replicated) on each other 20 MHz channels forming a composite channel. Thanks to the duplication of control-type frames in non-HT format, it is expected that every nearby non-HT (i.e. not compliant with 802.11ax) non-AP stations receiving the NFRP trigger frame (or a duplicate thereof) on its primary channel, then sets its NAV to the value specified in the NFRP trigger frame. This prevents these non-HT non-AP stations from accessing the channels of the composite channel during the TXOP.

Each non-AP STA receiving a frame is able to first analyze the received frame to determine whether it (the non-AP STA) is concerned with it, in particular to determine whether the non-AP STA is associated with the BSSID indicated in the TA field of the frame (or if the indicated BSSID belongs to a multiple BSSID set for which the non-AP STA is member of).

In case of positive determination, it then determines whether the received frame is a NFRP trigger frame 200, thanks to the type specified in Trigger Type field 320.

In the affirmative, the non-AP STA determines whether it is scheduled by the received NFRP trigger frame 200. It is made by checking whether its AID value (assigned to it by the AP during the association procedure) falls within the range [“Starting AID”; “Starting AID”+N_{STA}−1] as obtained from the fields UL BW 330, Starting AID 351 and Multiplexing flag 356 of the received NFRP trigger frame 200.

When the non-AP STA is not scheduled, nothing more happens at the station.

If it is scheduled by the NFRP trigger frame, the scheduled non-AP STA determines a RU tone set index, i.e. a RU tone set 210 on which the non-AP STA will transmit energy in response to the NFRP trigger frame. The non-AP STA usually selects a responding RU tone set based on the position of its AID within the above range, meaning the first RU tone set is assigned to the non-AP station having the Starting AID as own AID, and so on.

Table 27-32 of 802.11ax D8.0 describes an example of how the tones forming 40 MHz, 20 MHz channels are grouped into sets of tones.

For instance, 216 tones (indexed from −113 to −6 and 6 to 113) forming a 20 MHz channel are split into six bundles 250 of 36 continuous tones. Next each RU tone set is formed by two tones from each bundle (usually consecutive tones that are collocated from one bundle to the other), thereby resulting in 18 RU tone sets, each having a unique index RU_TONE_SET_INDEX (starting from 1). The two tones obtained from each bundle are assigned to two respective groups forming the RU tone set. It means that each RU tone set is formed of two groups of tones 210a and 210b.

For illustrative purposes, the tone set with RU_TONE_SET_INDEX=6 in a 20 MHz channel without spatiality is made of the two following groups of tones (subcarrier indices):

Group 210a: −103, −67, −31, 16, 52, 88

Group 210b: −102, −66, −30, 17, 53, 89

In this example, 6 tones are replicated in each group over the 20 MHz channel, each tone from one of the six bundles of tones 250.

A RU tone set is thus made of two adjacent groups of tones (−103 is adjacent to −102, −67 to −66 and so on), each group being made of non-adjacent tones (−103 not adjacent to −67 and so on).

Basically, the tone set index for the scheduled non-AP STA is computed from the difference between STA's AID value and “Starting AID” value: RU_TONE_SET_INDEX=STA's AID−Starting AID+1. For instance, if this difference plus 1 equals 6, the above-detailed tone set (with RU_TONE_SET_INDEX=6) is scheduled for the non-AP STA considered.

Next, the non-AP STA generates the NDP feedback report response to be sent to the AP.

In particular, the non-AP STA has to transmit energy on the first group 210a of subcarriers or tones to indicate a first response to the feedback type (field 353) polled by the NFRP trigger frame 200, and on the other hand, the non-AP STA must transmit energy on the second group 210b of subcarriers or tones to indicate a second response to the feedback type.

The response is named FEEDBACK_STATUS in the current D8.0 version of 802.11ax. For the Feedback Type field 353 set to 0 (Resource request),
FEEDBACK_STATUS is set to 0 (first response) when the non-AP STA requests UL resources for a number of buffered bytes between 1 and a resource request buffer threshold, using the Resource Request Buffer Threshold Exponent subfield in the most recently received NDP Feedback Report Parameter Set element sent by the AP with which the STA is associated (e.g. through management or beacon frames);
FEEDBACK_STATUS is set to 1 (second response) when the non-AP STA requests UL resources for a number of buffered bytes above the resource request buffer threshold.

The non-AP station thus determines the NDP feedback report response to be sent depending on the feedback type field in the NFRP trigger frame.

Table 27-32 of 802.11ax D8.0 specifies which group of tones within a tone set has to be used depending on the FEEDBACK_STATUS value.

Thus, the non-AP STA determines the FEEDBACK_STATUS value and therefore the group of tones to be used, either 210a or 210b, depending on the feedback it wishes to report to the AP.

Next, the non-AP STA transmits energy on the group corresponding to the FEEDBACK_STATUS value in the RU tone set of the determined RU_TONE_SET_INDEX.

For illustration purposes, Station 1 (corresponding to RU_TONE_SET_INDEX=1) transmits energy on its first group of tones 210a to provide a “first response” (as a consequence, group 210b is represented with a dash line). On the contrary, Station 2 (corresponding to RU_TONE_SET_INDEX=2) transmits energy on its second group of tones 210b to provide a “second response”.

Technically, the HE TB NDP Feedback PPDU 211 used as a feedback response is a single packet with no real data payload as shown in FIG. 3b. The PHY preamble 212 is emitted on 20 MHz width (thus several non-AP STAs simultaneously emit the same preamble) and the ‘payload’ is composed of a series of HE-LTF symbols 213, located on the tones forming the selected group 210a or 210b, to be used for the transmitted feedback (energy).

Next, the physical layer of the AP receives and decodes the RU tone sets where energy is present, to provide to its MAC layer a list of used RU_TONE_SET_INDEX where energy has been detected and the corresponding Feedback responses (FEEDBACK_STATUS values): in the example above, RU_TONE_SET_INDEX=1 has FEEDBACK_STATUS=0, and RU_TONE_SET_INDEX=2 has FEEDBACK_STATUS=1.

Thanks to the fields UL BW 330, Starting AID 351 and Multiplexing flag 356 of the NFRP trigger frame 200, the AP is able to retrieve that AID of each non-AP STA responding to the trigger frame 200. The MAC layer entity of the AP is thus able to determine those NDP-scheduled non-AP STAs which have responded and their FEEDBACK_STATUS values, hence their needs in terms of UL RUs.

As a result, the AP can send a subsequent trigger frame 220 to offer new opportunities (UL RUs) to the responding non-AP STAs, for example a ‘Basic’ type trigger frame or of any convenient type. The ‘Basic’ type trigger frame is signaled by a “Trigger Type” subfield 320 having value 0.

Based on an AP's decision and the collected feedback responses 211, the trigger frame 220 may define a plurality of resource units (RUs) 230 (here of 26 tones—of course other numbers of tones may be used) to responding non-AP STAs needing resources to transmit. The multi-user feature of OFDMA allows the AP to assign different RUs to different non-AP STAs in order to increase competition. This helps contention and collisions inside 802.11 networks to be reduced.

These RUs are scheduled RUs assigned to the feedback-responding non-AP STAs, using the retrieved AIDs.

The trigger frame 220 may for instance include a plurality of User Info fields (FIG. 3a) for a respective plurality of scheduled RUs, each User Info field setting an AID (so-called AID12 field) of the scheduled non-AP STA fora given RU in the channel.

The non-AP STAs thus receive the subsequent trigger frame 220 and determine whether they are scheduled (step S280 by checking the AIDs in the AID12 field of the User Info fields of trigger frame 220).

In the affirmative, the non-AP STA can use the RU scheduled to it (i.e. the one with the AID corresponding to the non-AP STA) and transmit data (HE TB PPDU) to the AP.

In the exemplary illustration, NDP-responding Station 1 and Station 2 are each granted an UL RU 230. As an example, Station 1 can emit a HE TB PPDU 231 in a first RU 230-1, and Station 2 can emit a QoS_Null with Buffer Status Report (the HE TB PPDU is a MAC-PDU with no data payload but with a MAC header containing a BSR) in a second RU 230-2. As the Qos_Null is smaller than the transmission duration specified in trigger frame 220, the second RU 230-2 is filled in with padding to match the transmission duration.

Upon receiving the HE TB PPDU 231, the AP acknowledges (or not) the data received on each RU by sending a multi-STA block acknowledgment (BA) response (240—FIG. 2a), making it possible for each sending non-AP STA to know when its data transmission is successful (reception of the ACK) or not (no ACK after expiry of a time-out).

These explanations show the intent of the NFRP trigger frame mechanism according to the current version of the 802.11ax standard: to receive feedbacks in a short time from a great number of associated non-AP stations.

The overall MU Uplink (UL) medium access sequence of FIG. 2a, including both NDP Feedback RUs and UL MU scheduled RUs, seems more efficient than conventional EDCA access scheme, especially in dense environments as envisaged by the 802.11ax standard. This is because the number of collisions generated by simultaneous medium access attempts and the overhead due to the medium access are both reduced. The NFRP trigger frame 200 allows information to be requested from 18 non-AP stations per 20 MHz channel (more with spatial multiplexing), and the Basic trigger frame 220 allows RUs to be proposed to up to 9 stations which have shown their interest to be triggered (by responding to the NFRP trigger frame).

Turning now to FIG. 2b, exemplary embodiments provide random access to the RU tone sets during the NDP short feedback report procedure. This is described with more details in the co-pending application GB1908800.4.

The AP 110 polls a large group of non-AP STAs to know their needs for transmission, by sending a random-access (RA) NFRP trigger frame 201 wherein the Starting AID field 351 is set to a predefined AID value defining a random access for the stations to the plurality of RU tone sets. This sharply contrasts with the “Starting AID” field conventionally used which defines the first AID of a restricted range of AIDs scheduled to respond to the NFRP Trigger frame.

For instance, the predefined AID value takes a value different from the AIDs the AP provides to the non-AP stations when registering, for instance it takes value 0 to allow only yet-associated non-AP stations to randomly access the RU tone sets, or takes value 2045 to allow only non-yet associated non-AP stations to randomly access the RU tone sets, or takes a BSSID index value to allow only non-AP stations of the BSS to randomly access the RU tone sets.

Any non-AP station 101-107 receives the RA-NFRP Trigger frame 201 and decodes it. If the receiving non-AP station belongs to a BSS (or virtual BSS) of the transmitting AP, the Trigger Frame is not filtered by the PHY layer as defined in the standard. The filtering is made on so-called “colors” defined in the 802.11ax standard, which mandates that the BSS colors of all the multiple BSSs managed by a single AP are the same.

The non-AP STA determines whether a random-access NFRP feedback procedure takes place. This is made by checking the value of the Starting AID field 351. If its value is a predefined AID value such as 0, BSSID indexes, or 2045 for instance, random access is provided. The non-AP STA thus checks whether it belongs to the group of non-AP stations targeted by the value.

In the affirmative, the non-AP STA determines whether it has interest in responding, in which case, the non-AP STA determines a random RU tone set 210 to send its short NDP feedback report response 211.

The selection of the RU tone set is made on a random basis by selecting an index from among the available indexes. All the RU tone sets are available for contention. Optionally, only the RU tone sets that fit into station capabilities are eligible for contention (e.g. a station operating on a limited band BW such as a 20 MHz-only station). All the non-AP stations targeted by the predefined AID value (e.g. all registered stations, all non-yet-registered stations, all stations of one or more BSSs, etc.) thus compete one each other to access the RU tone sets.

For instance, the non-AP STA randomly selects a RU tone set Index to send its short feedback: RA_NFRP_SET_INDEX=random [1, N_{STA}]. In a variant, a contention-based access method may be used, using a decrementing NFRP backoff, NBO, counter local to the non-AP station. The NBO is handled using NFRP Random Access contention parameters including a NFRP contention window. The RA_NFRP_SET_INDEX corresponding to NBO is selected, unless NBO is greater than N_{STA} in which case NBO is decreased by N_{STA} and the non-AP STA is not allowed to access the RU tone sets for this RA-NFRP trigger frame 201.

Next, the non-AP STA determines the FEEDBACK_STATUS and thereafter sends its NDP feedback report response by sending energy on the appropriate group of tones within the selected RU tone set with RA_NFRP_SET_INDEX.

As become apparent in the FIG. 2b, due to the random selection, some RU tone sets may be not selected due to randomization, so that the corresponding tone groups 210 are left unused. Such situation is shown by reference 210e in the Figure.

Also, the random selection of RA_NFRP_SET_INDEX may result in having two or more non-AP STAs selecting the same RU tone set and having the same response, FEEDBACK_STATUS. Such situation is shown by reference 210c in the Figure where a collision occurs.

Anyway, the AP receives and decodes the RU tone sets where energy is present, to provide to its MAC layer a list of used RU_TONE_SET_INDEX and the corresponding Feedback responses (FEEDBACK_STATUS values). At this stage, it is not possible for the AP to know which RU tone sets with energy are collided (210c) or not.

Next, the AP can send a subsequent trigger frame 221 to offer new transmission resources (data RUs) to the responding non-AP STAs, for example a ‘Basic’ type trigger frame or of any convenient type. Preferably, the scheduled RUs are of narrow width (26 tones) to offer a maximum of nine RUs per 20 MHz channel.

However, at this stage, the AP does not know which non-AP STAs have emitted energy on a given RU tone set 210. Consequently, it is not possible for the AP to schedule the responding non-AP STAs through their AIDs in the trigger frame 221.

The AP may thus assign a scheduled resource unit to a responding station using the index RU_TONE_SET_INDEX of the corresponding responding RU tone set: the AID (so-called AID12 field) associated with the scheduled RU is set to RU_TONE_SET_INDEX of a responding RU tone set.

However, in order to avoid these scheduled index-based AIDs to fall on conventionally-used AIDs (for BSS or for individual non-AP STAs, typically values from 1 to 2007 and some values below 2048 such as 2045 and 2046, and value 4095 is reserved to indicate start of a Padding field), the AID associated with the scheduled resource unit in the subsequent trigger frame may be built from the index RU_TONE_SET_INDEX of the responding RU tone set and from an offset value Offset_AID.

For instance, the AID12 field of a User Info field defining the scheduled RU may be set to RA_NDP_AID:

RA_NDP_AID=Offset_AID+RU_TONE_SET_INDEX+STARTING_STS_NUM*18*2^{BW}
where
STARTING_STS_NUM is parameter handling the spatial multiplexing. It is a station parameter that corresponds to a starting spatial stream number minus 1. It is set to 0 if the MultiplexingFlag 356 of the RA-NFRP trigger frame 600 is set to 0 (no spatial multiplexing), otherwise it is set as follows: STARTING_STS_NUM=entire_value (RU_TONE_SET_INDEX/(18*2^{BW})), and
the Offset_AID parameter is a predetermined offset value known by the stations. In some embodiments, the Offset_AID parameter is transmitted by an AP to the stations in a management frame, e.g. periodically in beacon frames.

Preferably, the Offset_AID parameter is selected such that any subsequent RA_NDP_AID falls outside the legacy range of Association Identifiers (AIDs) provided by the AP to associated non-AP STAs. For instance, the offset value is 2048 or above.

Using an offset value of 2048 to form the 12-bit AID field makes it possible to work on the MSB (set to 1) to easily distinguish between conventional AIDs and those used for the present invention. Furthermore, it allows scheduled RUs for non-AP STAs responding to the RA-NFRP trigger frame 600 to be mixed with scheduled RUs for other non-AP stations directly per their own AID value, with no risk of misunderstanding.

Any non-AP STA receiving the subsequent trigger frame 221 can thus determine whether it is scheduled by checking whether a resource unit is declared with an AID12 field set to the index RA_NFRP_SET_INDEX used by the said non-AP station when responding to the RA-NFRP trigger frame 201. It can then send its TB Data PPDU 230 over the RU. For instance, the first RU 230-1 is assigned to RA_NFRP_SET_INDEX=1 (i.e. to STA₁), the second RU 230-2 is assigned to RA_NFRP_SET_INDEX=4 (i.e. to STA₂₀) while the third RU 230-3 is assigned to RA_NFRP_SET_INDEX=3 (where the collision 210c has occurred).

The AP 110 thus receives the TB Data PPDUs 230 over the multiple scheduled RUs. It can then acknowledge (or not) the data on each RU by sending a multi-STA block acknowledgment (BA) response 240, making it possible for each sending non-AP STA to know when its data transmission is successful (reception of the ACK) or not (no ACK after expiry of a time-out).

For instance, it may not acknowledge data over RU 230-3 as it detects a transmission error interpreted as a collision, since the multiple stations having responded simultaneously on 210c have also transmitted simultaneously over the third RU 230-3.

The AP 110 may obtain an AID of the responding non-AP stations using the MAC addresses (known from the registration procedure) specified in the correctly received (i.e. without collision) TB Data PPDU 230. The stations are thus only discriminated at this final stage. The AIDs are used for the acknowledgment 240.

The overall MU Uplink (UL) medium access sequence of FIG. 2b, including both random NDP Feedback RUs and UL MU scheduled RUs, seems largely more efficient than conventional UORA scheme of 802.11ax. This is because the collision is largely performed on the NDP feedback responses 211 which are shorter in duration, and the data RUs used for TB PPDU 230 are never empty.

The overall scheme (random-based NDP feedback report procedure supplemented with a subsequent trigger frame—FIGS. 2a and 2b) thus offers an efficient MU UL random scheme for the non-AP STAs because the random-access is moved to the short NDP feedback report procedure compared to conventional 802.11ax UORA with large duration. Indeed, one unused RU tone set has lower impact on network efficiency than one unused OFDMA RU (UORA).

Although these embodiments (see FIGS. 2a and 2b) rely on trigger frames sent by the AP for a multi-user (MU) uplink (UL) transmissions, equivalent mechanisms can be used in the present invention in a centralized or in an ad hoc environment (i.e. without an AP) to offer subsequent transmission resources. It means that the operations described below with reference to the AP may be performed by any polling station in an ad hoc environment. In addition, subsequent scheduling different from the 802.11ax/be UL MU operation may be used to provide scheduled transmission resources to the NFRP responding polled stations.

A difficulty arises with the above schemes when the non-AP stations rely on different 802.11 technologies. NFRP feedback scheme results in transmitting energy on given RU tone sets, which can be performed by devices belonging to any 802.11 technology. As only energy is received as NFRP feedback, the AP needs to know what kind of station it will address.

For instance, some HE STAs (compliant with 802.11ax) may coexist in the same BSS with EHT STAs (compliant with 802.11be), and may all participate to the NDP feedback report procedure. However, the mechanism to trigger or schedule the subsequent MU UL transmission is different for HE STAs and EHT STAs. Indeed, the AP has to send trigger frames that have different formats: a Basic trigger frame according to the HE format (802.11ax) for HE STAs vs. a Basic trigger frame according to the EHT format (802.11be) for EHT STAs. The AP consequently needs to know the 802.11 technology used by each non-AP station responding during the NDP feedback report procedure in order to trigger their MU UL transmissions using the appropriate trigger frame format. As only energy is received as NFRP feedback, an innovative mechanism has to be provided.

In this respect, the present invention offers such a mechanism to provide such knowledge to the AP.

In particular, it is proposed to signal, in the NFRP trigger frame, one or more technologies from amongst a plurality of technologies that are available at the AP (i.e. the polling station) to provide subsequent transmission resources to the polled stations. This makes it possible for the AP to selectively poll stations regarding certain technologies. Any polled station (i.e. targeted by the NFRP trigger frame) can determine whether it is compatible with at least one signaled technology. In the affirmative, a NDP feedback report response related to the compatible technology (or technologies if plural) can be sent by the polled station.

The AP receiving all the responses related to different signaled technologies is then aware of which technology is used by which responding polled station. It turns out that the AP can efficiently schedule them in subsequent MU UL transmissions: using HE Basic trigger frames for stations (HE STAs) having responded with a NDP feedback report response related to the HE technology and using EHT Basic trigger frames for stations (EHT STAs) having responded with a NDP feedback report response related to the EHT technology. In other words, the AP may thus provide, using one of the signaled technologies (e.g. HE), subsequent transmission resources (data RUs in a MU UL transmission) to responding stations (HE STAs) of feedback report responses related to the same signaled technology (HE technology). Advantageously, the AP may even schedule an additional MU UL transmission for other technologies: it may, simultaneously or consecutively to the subsequent transmission resources, provide, using another signaled technology (e.g. EHT), other subsequent transmission resources over a distinct channel (20 MHz channel) to responding stations (EHT STAs) of feedback report responses related to the same other signaled technology. A given polled station may be involved in one or more of the scheduled subsequent MU UL transmissions, for instance if it is compatible with both technologies (EHT STAs are downward compatible with HE) and the AP schedules it in both MU UL transmissions.

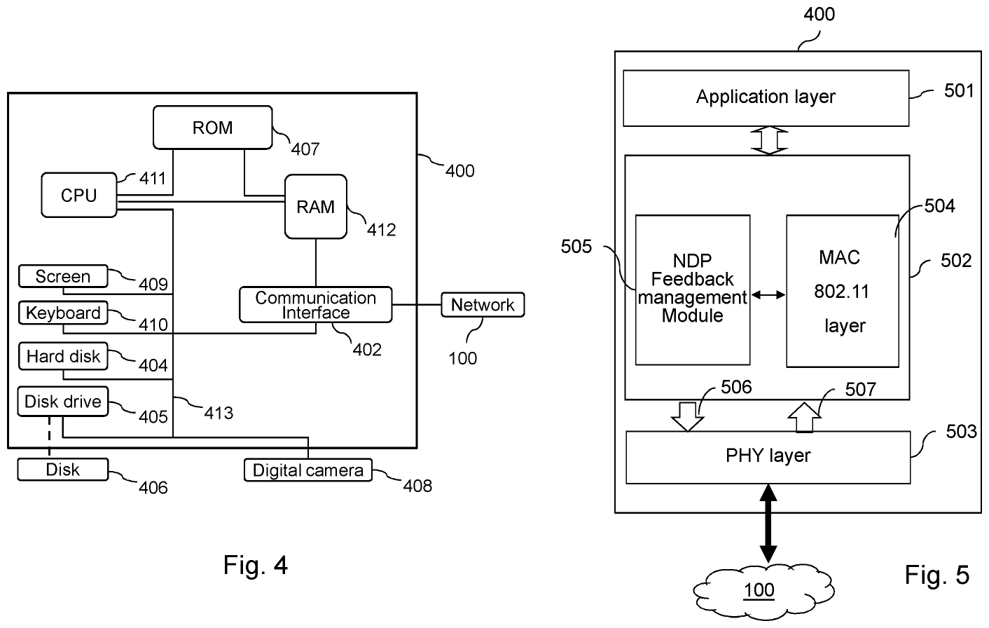

FIG. 4 schematically illustrates a communication device 400 of the radio network 100, either the AP 110 or any non-AP STA 101-107, configured to implement at least one embodiment of the present invention. The communication device 400 may preferably be a device such as a micro-computer, a workstation or a light portable device. The communication device 400 comprises a communication bus 413 to which there are preferably connected:
a central processing unit 411, such as a microprocessor, denoted CPU;
a read only memory 407, denoted ROM, for storing computer programs for implementing the invention;
a random-access memory 412, denoted RAM, for storing the executable code of methods according to embodiments of the invention as well as the registers adapted to record variables and parameters necessary for implementing methods according to embodiments of the invention; and
at least one communication interface 402 connected to the radio communication network 100 over which digital data packets or frames or control frames are transmitted, for example a wireless communication network according to the 802.11ax/be protocols. The frames are written from a FIFO sending memory in RAM 412 to the network interface for transmission or are read from the network interface for reception and writing into a FIFO receiving memory in RAM 412 under the control of a software application running in the CPU 411.

Optionally, the communication device 400 may also include the following components:
a data storage means 404 such as a hard disk, for storing computer programs for implementing methods according to one or more embodiments of the invention;
a disk drive 405 for a disk 406, the disk drive being adapted to read data from the disk 406 or to write data onto said disk;
a screen 409 for displaying decoded data and/or serving as a graphical interface with the user, by means of a keyboard 410 or any other pointing means.

The communication device 400 may be optionally connected to various peripherals, such as for example a digital camera 408, each being connected to an input/output card (not shown) so as to supply data to the communication device 400.

Preferably the communication bus provides communication and interoperability between the various elements included in the communication device 400 or connected to it. The representation of the bus is not limitative and in particular the central processing unit is operable to communicate instructions to any element of the communication device 400 directly or by means of another element of the communication device 400.

The disk 406 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to embodiments of the invention to be implemented.

The executable code may optionally be stored either in read only memory 407, on the hard disk 404 or on a removable digital medium such as for example a disk 406 as described previously. According to an optional variant, the executable code of the programs can be received by means of the communication network 403, via the interface 402, in order to be stored in one of the storage means of the communication device 400, such as the hard disk 404, before being executed.

The central processing unit 411 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 404 or in the read only memory 407, are transferred into the random-access memory 412, which then contains the executable code of the program or programs, as well as registers for storing the variables and parameters necessary for implementing the invention.

In a preferred embodiment, the apparatus is a programmable apparatus which uses software to implement the invention. However, alternatively, the present invention may be implemented in hardware (for example, in the form of an Application Specific Integrated Circuit or ASIC).

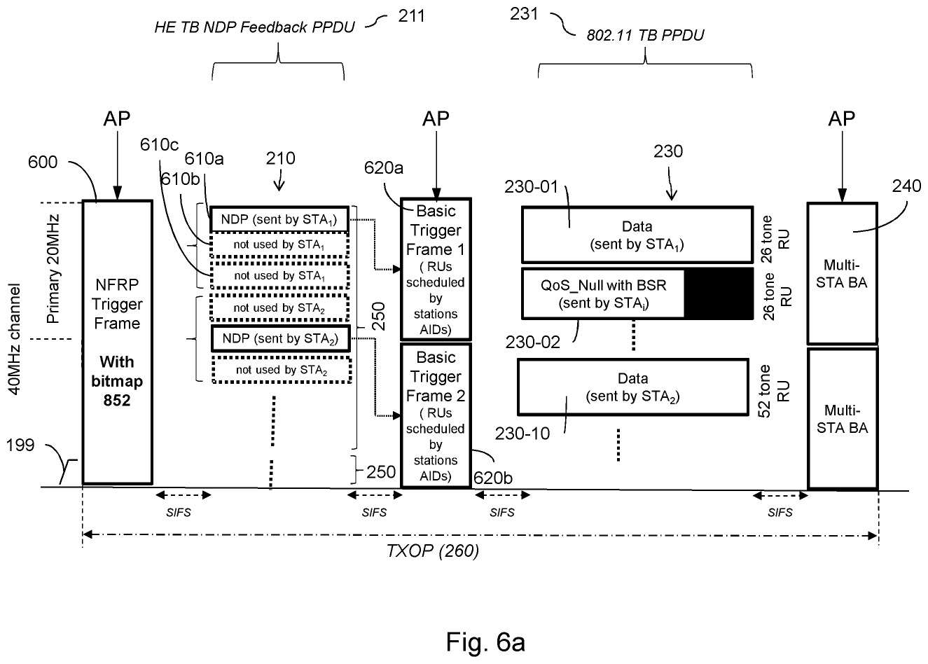

FIG. 5 is a block diagram schematically illustrating the architecture of the communication device 400 adapted to carry out, at least partially, the invention. As illustrated, communication device 400 comprises a physical (PHY) layer block 503, a MAC layer block 502, and an application layer block 501.

The PHY layer block 503 (e.g. a 802.11 standardized PHY layer) has the task of formatting, modulating on or demodulating from any 20 MHz channel or the composite channel, and thus sending or receiving frames over the radio medium used 100. This may be 802.11 frames, for instance single-user frames, such as control frames (e.g. ACK, Trigger Frame), MAC data and management frames. The frames are based on a 20 MHz width to interact with legacy 802.11 stations or with 802.11ax/be stations in a legacy mode (such as for Trigger Frames). MAC data frames of OFDMA type have preferably a width smaller than 20 MHz legacy (typically 2 or 5 MHz). NDP frames have preferably a PHY header transmitted on 20 MHz width and a short payload consisting on energy located on non-contiguous subcarriers or tones, to/from that radio medium.

The MAC layer block or controller 502 preferably comprises a MAC 802.11 layer 504 implementing conventional 802.11ax/be MAC operations, and an additional block 505 for carrying out, at least partially, embodiments of the invention. The MAC layer block 502 may optionally be implemented in software, which software is loaded into RAM 412 and executed by CPU 411.

Preferably, the additional block 505 referred to as NDP Feedback Management module is configured to implement steps according to embodiments that are performed by the communication device 400, notably transmitting operations for a transmitting/responding station and receiving operations for a receiving station.

In particular, the NDP Feedback Management module 505 at a polling station (e.g. an AP or any station in an ad hoc network) is in charge of signaling one or more technologies in a NFRP trigger frame, which technologies may be used by the polling station to trigger or schedule subsequent transmission resources to the polled stations. Data RUs in subsequent MU UL transmissions is one possible implementation. Preferably, the signaling is made using a bitmap where a plurality of bits correspond to a plurality of technologies available at the polling station, respectively. Thus, the signaling of the one or more technologies includes setting a respective bit of the bitmap to an enabled value (e.g. bit set to 1) for each of the signaled technologies.

The NDP Feedback Management module 505 at a polled station is in charge of retrieving such signaling, e.g. the bitmap, and of checking whether the station is compatible with one of the signaled technologies. In the affirmative, a NDP Feedback Report response linked to the compatible technology (or technologies) may be sent to the polling station.

Interfaces 506 and 507 are used by the MAC and PHY layer blocks to interact and to exchange information.

On top of the Figure, application layer block 501 runs an application that generates and receives data packets, for example data packets of a video stream. Application layer block 501 represents all the stack layers above MAC layer according to ISO standardization.

Embodiments of the present invention are now illustrated using various exemplary embodiments.

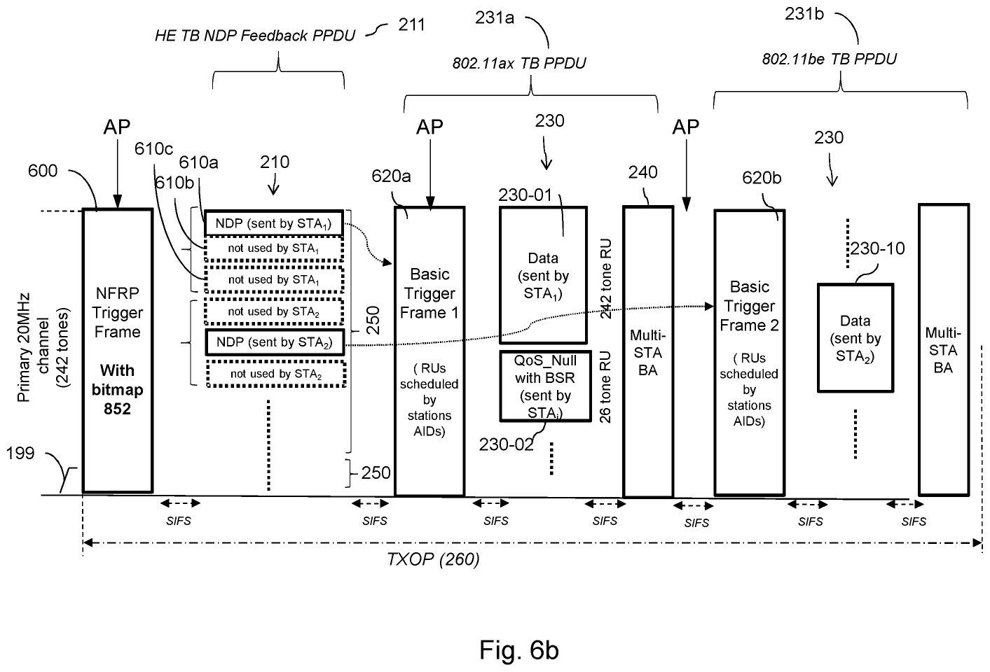

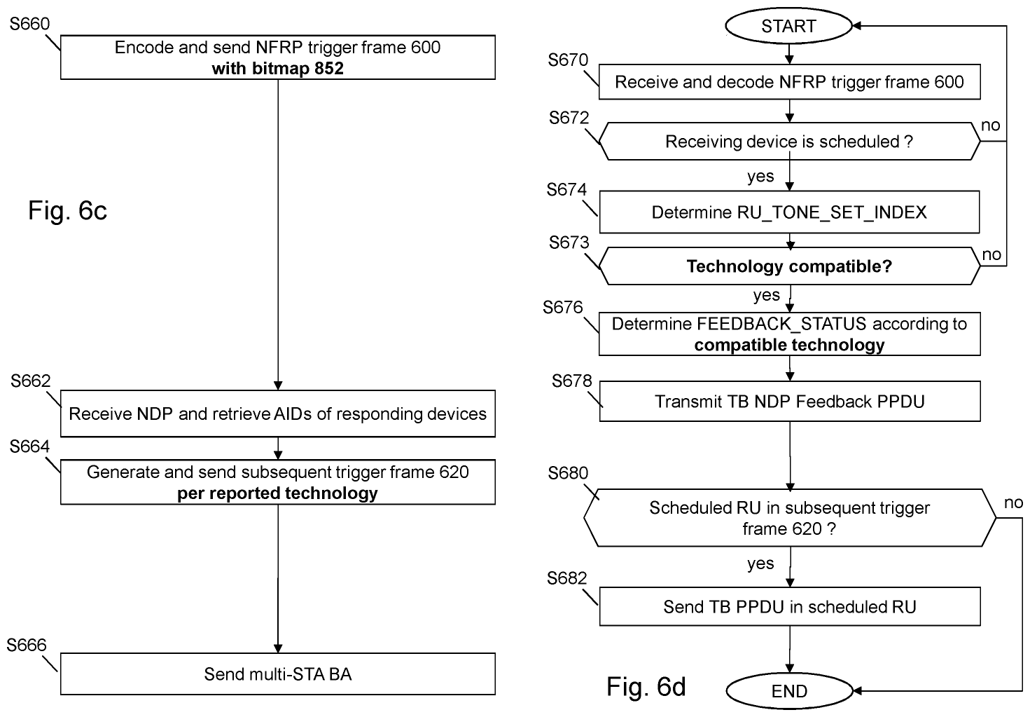

FIG. 6 illustrate scenarios based on NFRP trigger frames scheduling RU tone sets for specific polled stations, according to embodiments of the invention. The NFRP trigger frame used thus specifies a range of association identifiers, AIDs, designating polled stations allowed to send NDP feedback report responses on the RU tone sets.

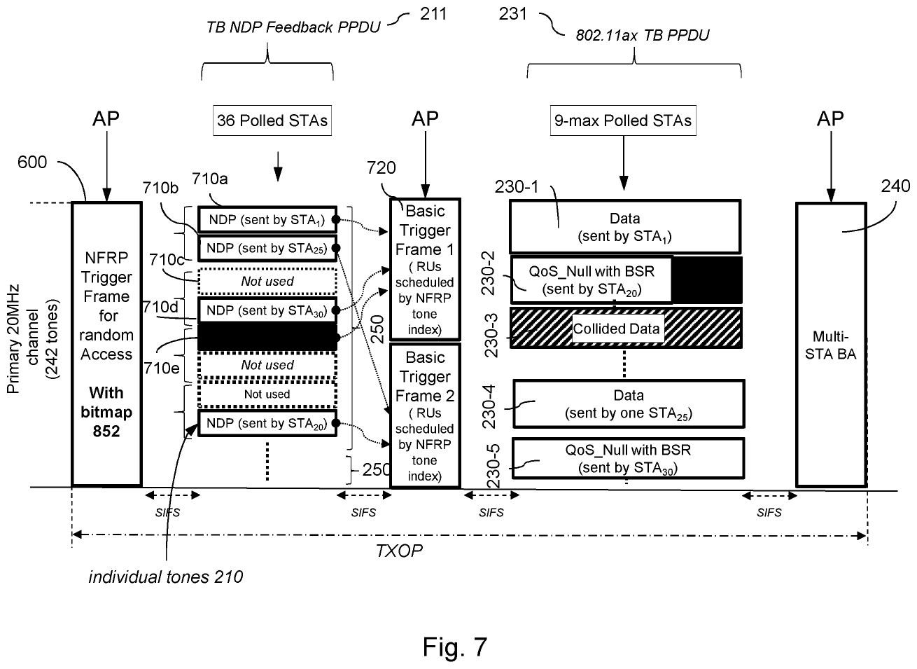

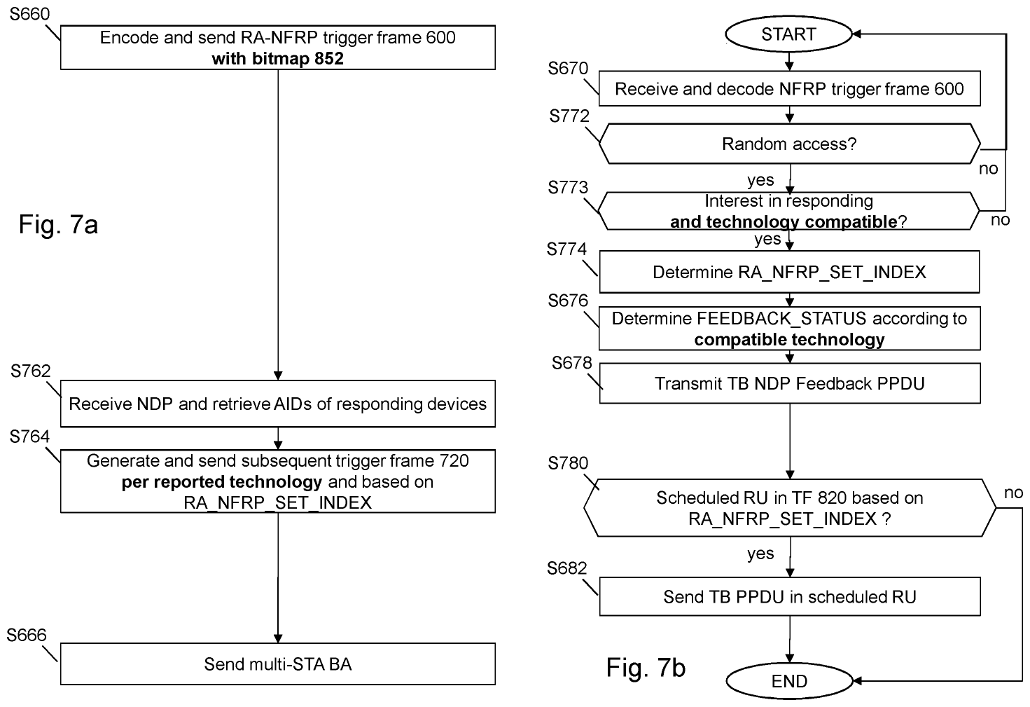

FIG. 7 illustrate a scenario based on RA-NFRP trigger frames, according to embodiments of the invention. An association identifier, AID, field in the NFRP trigger frame thus includes a predefined AID value defining a random access for the polled stations to the plurality of RU tone sets.

FIG. 6a uses the same timeline as FIG. 2a to illustrate first embodiments of the invention where simultaneous subsequent transmission resources (here RUs in MU UL transmissions) are provided to polled stations after a NDP short feedback report procedure. Resources (data RUs) offered using a first technology (e.g. HE−802.11ax trigger frame) over a channel are simultaneous to resources (data RUs) offered using a second technology (e.g. EHT−802.11 be trigger frame) over another 20 MHz channel.

FIG. 6b shows an alternative to FIG. 6a, where consecutive subsequent transmission opportunities (here MU UL transmissions) are provided after a NDP short feedback report procedure. Resources (data RUs) offered using a first technology (e.g. HE−802.11ax trigger frame) over a 20 MHz channel are consecutive in time to resources (data RUs) offered using a second technology (e.g. EHT−802.11 be trigger frame) over the same 20 MHz channel.

FIGS. 6c and 6d illustrate, using flowcharts, corresponding general steps at the polling station (e.g. the AP) and a polled station (e.g. a non-AP STA), respectively. The reference numbers are unchanged when referring to the same elements, frames and steps as in FIGS. 2a and 2b.

The flowcharts of FIGS. 6c and 6d is an enhanced method compared to the one described above with reference to FIG. 2a. The enhancement mainly consists in handling the signaling of the technologies in the NFRP trigger frame and the corresponding NDP Feedback report responses, and then in using these responses to schedule subsequent transmission resources to the polled stations.

At step S660, upon obtaining access to the medium (EDCA), the polling station 110 polls a large group of polled stations to know their needs for transmission, by sending NFRP trigger frame 600 identifying the polled stations and signaling technologies according to the invention.

For instance, Starting AID field 351 is as specified in FIG. 2a: set to an AID starting a range of AIDs of polled stations. The range width is defined by the N_{STA} value.

In a variant concerning the so-called multi-AP technology, Starting AID field 351 may be set to a value identifying a first AP (e.g. an AID or any equivalent means, herebelow referred to as AP identifiers) and starting a range of AP identifiers (the width of which may be defined by N_{STA} above).

Multi-AP technology is considered as one major trend for 802.11be that consists in enabling some degree of collaboration among neighbouring EHT APs in order to have a more efficient utilization of the limited time, frequency and spatial resources available. This is particularly important when the neighbouring EHT APs operate over the same selected (20 MHz) channel or channels. With such a technology, two neighbouring EHT APs may share resources in terms of frequency or time and, in this way, prevents interferences. EHT APs that collaborate together to share resources are referred to as coordinated APs. Moreover, the data transmission established by coordinated APs is referred as Multi-AP transmission. The EHT AP sharing its granted resources with coordinated APs may be referred to as coordinator AP. Coordinated APs thus act as stations with regards to the coordinator AP.

A multi-AP group thus consists in a set of EHT APs having common features, for instance having the same Extended Service Set (ESS) and being close enough to each other to communicate. It is assumed that each EHT AP of a multi-AP group knows at any time the composition (the list of APs) of the multi-AP group and are able to identify each other. The multi-AP group may be either static, or dynamic and then updated each time one AP of the group gains access to the medium.

NFRP trigger frame 600 can thus be used by the coordinator AP to known whether coordinated APs intend to participate in a current multi-AP transmission: Starting AID subfield 352 may be set to a first coordinated AP of the multi-AP group. In a variant, Starting AID subfield 352 may be set to an identifier (e.g. BSSID) associated with the multi-AP group.

NFRP trigger frame 600 also signals some technologies available at the polling station to schedule or trigger subsequent transmission resources for the polled stations. As mentioned above, a bitmap may be used. However, this is not mandatory.

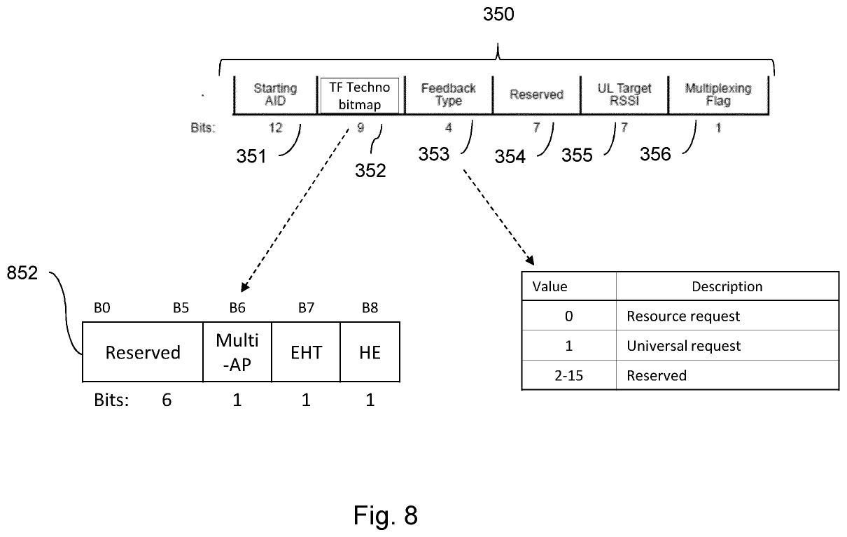

The signaling of technologies to schedule/trigger subsequent transmissions may be included in the User Info field 350 of NFRP trigger frame 600. FIG. 8 shows an exemplary implementation of a signaling bitmap in User Info field 350.

In a variant not shown, the signaling is included in Trigger Dependent Common Info field 340 (which has a variable length) of NFRP trigger frame 600.

As shown in FIG. 8, a signaling bitmap 852 is provided within the 9-bit reserved subfield 352 of User Info field 350.

Signaling bitmap 852 is provided as an exemplary implementation for supporting a list of 802.11 technologies. As an example, each bit in bitmap 852 is associated with a corresponding technology and indicates whether the corresponding technology is inquired by the polling station (to know resource needs for polled stations compatible with this technology).

For instance each bit of Bitmap 852 is set to 1 to indicate that the polling station supports the corresponding technologies and wishes to know the resource needs by polled stations compatible with these technologies. Otherwise, it is set to 0 (meaning that a given technology is either not supported or the polling station does not wish to know corresponding stations' resource needs).

To keep backward compatibility with HE stations, the presence of bitmap 852 is signaled, in the NFRP trigger frame, through Feedback Type subfield 353 set to a value different from 0. Indeed, when subfield 353 is set to 0, all stations have to ignore subfield 352 (hence bitmap 852) while when subfield 353 is set to another value, HE stations will ignore the entire

NFRP trigger frame 600 (because the Feedback type has an unknown value) and EHT stations will consider NFRP trigger frame 600 with bitmap 852.

As an example, value ‘1’ (named “Universal request”) can be used in Feedback Type subfield 353 for this purpose. This naming indicates the proposed scheme may be universally used by stations supporting various 802.11 technologies.

Also, different non-zero values may be used for subfield 353 to signal different formats for bitmap 852.

In the example shown, three technologies are considered in bitmap 852.

The first one is the HE technology which relies on using a Basic trigger frame according to the 802.11ax D8.0 standard to schedule or trigger subsequent transmission resources/opportunities. The second one is the EHT technology which relies on using a Basic trigger frame only recognized by 802.11be or upper version stations to schedule or trigger subsequent transmission resources/opportunities. The third one is the multi-AP technology that provides (schedules or triggers) transmission resources to other APs.

Of course, other technologies may be considered as well as only a subpart of these three technologies.

As shown in the Figure, bit B8 of bitmap 852 may signal the HE technology, bit B7 may signal the EHT technology and bit B6 may signal the multi-AP technology. Bits B0-B5 may be reserved bits to allow other technologies to be added in the future, hence keeping the mechanism as scalable for future use.

For instance, bit B8 may be set to 1 to signal that the polling station intends to trigger stations using an 802.11ax (HE) basic TF and therefore polls the compatible stations (i.e. HE and EHT stations) about their resource needs.

Similarly, bit B7 may be set to 1 to signal that the polling station intends to trigger stations using an 802.11 be (EHT) basic TF and therefore polls the compatible stations (i.e. EHT stations) about their resource needs.

NFRP trigger frame 600 is thus sent by the polling station over a 20 MHz primary channel and possibly over additional 20 MHz channels, thereby reserving a transmission opportunity (TXOP) corresponding to the duration specified inside the NFRP trigger frame.

Each station receiving NFRP trigger frame 600 is able to first analyze the received frame to determine whether it is concerned with it (step S670).

For instance, the station may determine whether it is associated with the BSSID indicated in the TA field of the frame (or if the indicated BSSID pertains to a multiple BSSID set for which the station is member of).

For the case of a multi-AP coordinated scheme, the station (i.e. a coordinated AP) determines whether the indicated BSSID in the TA field of the frame belongs to a broadcast BSSID or a BSSID set indicating a multi-AP group for which the station is member of.

In case of positive determination, the station then determines whether the received frame is indeed a NFRP trigger frame, thanks to the type specified in Trigger Type field 320.

Next to step S670, the station determines (step S672) whether it is scheduled by the trigger frame 600.

This may include, for a non-AP station, determining whether its AID belongs to the range of AIDs [“Starting AID”; “Starting AID”+N_{STA}] specified in NFRP trigger frame 600. For a coordinated AP, this may include determining whether its AP identifier (e.g. BSSID) is specified in NFRP trigger frame 600 or belongs to a range of identifiers specified in NFRP trigger frame.

Note that the number N_{STA} of polled stations may vary depending on how many technologies are signaled in NFRP trigger frame 600. Indeed, as explained below, the number of tones forming each RU tone set may vary and depend on the number of signaled technologies, to allow the polled stations to respond for each signaled technology.

When the station is not scheduled, nothing more happens.

If it is scheduled by the NFRP trigger frame 600, the scheduled receiving device determines (step S674) a RU tone set index RU_TONE_SET_INDEX as described above from [1, N_{STA}].

Next, the station retrieves bitmap 852 should the Feedback Type field 353 be set to 1 (otherwise conventional processing is made) and then determines (step S675) whether it is compatible with one or more of the signaled technologies (i.e. technologies for which the associated bit in Bitmap 852 is set to 1) and has interest in responding to the frame 600.

For instance, a HE station may consider it is compatible only with the HE technology, while an EHT station may consider it is compatible with both the HE and EHT technologies.

If no compatible technology is found amongst the signaled technologies, nothing more happens.

In case of positive determination at step S675, the station determines (step S676) the NDP feedback report response, FEEDBACK_STATUS, to be sent.

The number of possible responses (i.e. number of possible values for FEEDBACK_STATUS) may depend on the number of signaled technologies. Indeed, a station must be allowed to indicate for which technology it is compatible.

While in the conventional mechanism, two groups of tones are provided within each RU tone set, embodiments may now provide that each RU tone set is made of a plurality of groups of tones, each group being associated with a respective one of the signaled technologies (for which bit in bitmap 852 is set to 1). Therefore, where three technologies are signaled, three groups of tones are provided per RU tone set. By keeping 6 tones per group, this increases the number of tones to 18 per RU tone set, and thus decreases the number of RU tone sets per 20 MHz channel (to 12), hence the number N_{STA}.

Optionally, instead of providing a group of tones per each signaled technology (i.e. with bit set to 1), a tone group may be provided per each technology listed in the bitmap (whatever the value of the corresponding bit): the RU tone set size would become dynamic and dependent from the size of bitmap 852. However, this would waste space in the resulting RU tone sets, since some tone groups will never be used.

As an example, when the polling station (AP 110 for instance) wants to obtain a feedback for three technologies, it may set bits B6, B7 and B8 all to one. As a result, each RU tone set is made of three groups of tones, wherein:
the first group with tone 610a is to be used by a polled station to indicate compatibility with the HE format and resource needs,
the second group with tone 610b is to be used by a polled station to indicate compatibility with the EHT format and resource needs,
the third group with tone 610c is to be used by a polled station to indicate compatibility with the multi-AP technology.

Consequently, FEEDBACK_STATUS may take values from 0 to 7.

When only two bits are set to 1 in bitmap 852, the convention RU tone set repartition can be used (two groups per RU tone set). The same repartition can also be used when a single bit is set to 1 in bitmap 852.

Note that if a bit is set to 0 in between two bits set to 1 (e.g. B8=B6=1 and B7=0), the two-tone groups considered are contiguous (e.g. tones corresponding to B6 and B8 are contiguous).

Of course, any variant for forming the RU tone sets can be envisaged starting from the available 216 tones (e.g. number of bundles 250 could be lower than 6, which means the replication of tone set is lower).

Finally, at step S676, the station has determined the FEEDBACK_STATUS value and therefore the group of tones to be used, either 610a, 610b etc., depending on the feedback it wishes to report to the AP.

In particular, the NDP feedback report response (FEEDBACK_STATUS value) may be provided in relation to two or more signaled (compatible) technologies.

Next at step S678, the station transmits the NDP Feedback Report response. In particular, a NDP feedback report response related to a signaled technology includes conveying energy on the respective group of tones within the responding RU tone set. In other words, the station transmits energy on the tone group or groups corresponding to the FEEDBACK_STATUS value within the RU tone set of the determined RU_TONE_SET_INDEX.

With reference to FIG. 6a, NFRP trigger frame 600 provides bitmap 852 with three signaled technologies (with bit set to 1). Therefore, each feedback response has to deal with three tones 210.

Station 1 (corresponding to RU_TONE_SET_INDEX=1 and wanting to express a FEEDBACK_STATUS for a first signaled technology) transmits energy only on the first group of tones 610a (as consequence, group 610b and 610c are represented with a dash line). On the contrary, Station 2 (corresponding to RU_TONE_SET_INDEX=2 and wanting to express a FEEDBACK_STATUS for a second signaled technology) transmits energy on the second group of tones 610b. Of course, a station may emit on two or more groups of tones to indicate it accepts to be provided with subsequent transmission resources using any two or more technologies.

Next, the physical layer of the polling station receives and decodes (S662) the RU tone sets where energy is present, to provide its MAC layer with a list of used RU_TONE_SET_INDEX and the corresponding Feedback responses (FEEDBACK_STATUS values).

Thanks to the RU_TONE_SET_INDEX, the polling station is able to retrieve the AID of each responding polled station.

At step S664, the polling station can send subsequent trigger frames 620 to offer new transmission resources (data RUs) to some responding polled station. This triggering is based on the received feedback. Indeed, the polling station will use a specific technology to trigger only polled stations having responded they are compatible with this technology (through the value of FEEDBACK_STATUS, corresponding to whether energy has been received on the tone group of this technology).

Of course, the polling station may also trigger other stations (having not responded to the NFRP trigger frame 600), provided it is aware these stations have resource needs and are compatible with the technology used. This information may be retrieved from previous NDP Feedback Report procedures.

In the example shown in FIG. 6a, two MU UL transmissions are simultaneously triggered by the polling station on two separate channels (here 20 MHz channel each, but they could be wider and of different widths).

For example, a first HE Basic type trigger frame 620a is sent on a first 20 MHz channel to trigger HE only stations, and a second EHT Basic type trigger frame 620b is sent on a second 20 MHz channel to trigger EHT-compatible stations.

In the example of the Figure, the data RUs 230 are scheduled RUs assigned to responding polled stations, using their AIDs as retrieved at step S662.

The trigger frames 620a and 620b may for instance have the same transmission duration, by considering padding to align their end-time. They preferably also indicate a same duration for the triggered PPDUs (i.e. UL length), in order also to align them in time.

To facilitate the identification of a compatible trigger frame for the polled stations, the trigger frames may be transmitted on channels depending on the bit position of their technology in Bitmap 852. For instance, the HE Basic type trigger frame 620a corresponds to the technology signaled in bit B8, hence it is transmitted on the first 20 Mhz channel (primary channel). The EHT Basic type trigger frame 620b corresponds to the technology signaled in bit B7, hence it is transmitted on the second 20 Mhz channel. And so on.

In a variant, the former (oldest) technology may be used in the first channel of a list of channels, and so on.

The other steps of FIGS. 6c and 6d are conventional ones.

The stations (either non-AP STAs and/or APs in case of multi-AP) thus receive the subsequent trigger frames 620 and determine whether they are scheduled with data RUs (step S680).

In the affirmative, the triggered stations can use their scheduled data RU and transmit (step S682) their data to the polling station using the appropriate technology.

According to the exemplary illustration, Station 1 and Station 2 can thus be granted each a data RU 230, by separate trigger frames 620 since they rely on different technologies. For instance, Station 1 emits a HE TB PPDU 231 in a first RU 230-01. For sake of illustration, another Station ‘i’ emits a QoS_Null with Buffer Status Report in a second RU 230-02. In parallel in response to trigger frame 620b, Station 2 is triggered on a distinct channel and also emits a TB PPDU 230-10, but now following an EHT format.

Upon receiving the TB PPDUs 230, the AP acknowledges (or not) the data on each RU by sending multi-STA block acknowledgment (BA) responses (240) on each triggered 20 MHz channel. This is step S666.

FIG. 6b shows a similar scenario to FIG. 6a where the subsequent trigger frames 620 are emitted successively (and no longer simultaneously) over the same channel during the granted TXOP. The trigger frames 620 may thus use the full operating band.

Advantageously this offers simplicity as no alignment of the frames is required (TF, TB PPDUs).

Furthermore, the same polled station that is compatible with multiple technologies (e.g. an EHT station is compatible with HE and EHT) may be involved in both subsequent MU UL transmissions, hence obtaining more bandwidth to transmit data.

The order of the successive trigger frames (corresponding to various technologies) may follow the order of the bits in Bitmap 852 (corresponding to the technologies). Alternatively, the trigger frame 620 of the former technology appears first (e.g. HE TF precedes an EHT TF).

Under this mode of operation, step S680 is slightly modified in such a way that the station may have to receive several subsequent trigger frames before determining in which one (ones) it is scheduled.

Preferably, the polling station has the choice to use the triggering scheme of FIG. 6a or the triggering scheme of FIG. 6b. In that case, to advise the polled stations, the polling station may signal in the NFRP trigger frame 600 whether the subsequent trigger frames 620 are simultaneous (i.e. in parallel) or consecutive (i.e. in sequence or cascade). Reserved bit B63 of the Common Info field 310 may be used to this purpose: for instance, bit B63 is set to 1 to indicate simultaneous trigger frames (FIG. 6a), or set to 0 otherwise (FIG. 6b).

These embodiments clearly show that, even if EHT stations are present in the network, it is possible to have a subsequent triggering phase with a simpler format and operations than the 802.11be operations. This is useful for low-end stations that do not support non-contiguous (punctured) operations nor larger bandwidths, or to still let stations enough time to be prepared for subsequent polling after having decoded the HE Basic TF.

FIG. 7 illustrates another scenario based on a RA-NFRP trigger frame, and FIGS. 7a and 7b illustrate, using flowcharts, corresponding general steps at the polling station and a polled station, respectively. The reference numbers are unchanged when referring to the same elements.

The mechanisms are the same as those described above for the random approach (FIG. 2b) and for the technology signaling (FIGS. 6a-6d).

At step S660, the RA-NFRP trigger frame 600 polls a large group of polled stations to know their needs for transmission. A predefined AID value is used to define a random-access for the stations to the plurality of RU tone sets. Furthermore, technologies are signaled, for instance using bitmap 852 and setting Feedback Type subfield 353 to 1.

The RA-NFRP Trigger frame 600 is received by a station at step S670, and then decoded. At step S772, the non-AP STA determines whether a random-access NFRP feedback procedure takes place, based on the AID value.

At step S773, the station determines whether it has an interest to respond to the NFRP trigger frame 600 and further whether it is compatible with one of the signaled technologies.

In the affirmative, the process goes on at step S774 where a RU tone set is selected as described above (FIG. 2b), hence obtaining RA_NFRP_SET_INDEX from [1, N_{STA}].

Note that the number N_{STA} of RU tone sets available may depend on the number of signaled technologies (bits set to 1) in the bitmap, or on the size of the bitmap (i.e. the number of technologies regardless of the values of their corresponding bits in the bitmap).

These responses are received and decoded by the polling station at step S762.

FIG. 7 illustrates a scenario with two signaled technologies in such a way 18 RU tone sets are provided, each formed of two groups of tones.

Next, at step S676, the station determines its response, i.e. the FEEDBACK_STATUS value according to the technologies signaled in bitmap 852.

The station then sends (S678) its NDP Feedback Report response 710 in the RU tone set RA_NFRP_SET_INDEX, by transmitting energy on the appropriate tone group or groups therein.

As shown in FIG. 7, the random selection of RA_NFRP_SET_INDEX may result in having two stations selecting the same RU tone set index.

The two stations may reply according to different technologies (i.e. using different tone groups) as shown by references 710a and 710b. In that case, the polling station will be able to separately trigger each station by trigger frames 720 according to the different technologies.

The two stations may also reply according to the same technology (i.e. using the same tone group) as shown by references 710e. In that case, a collision occurs. The polling station is not yet aware of it.

Next, at step S764, the polling station can send subsequent trigger frames 720 to offer new transmission resources (data RUs) to the responding polled stations. The scenario shown in the Figure provide simultaneous trigger frames according to two technologies (e.g. HE and EHT Basic trigger frames) as already explained with reference to FIG. 6a. In a variant, consecutive trigger frames (as in FIG. 6b) can be sent on the same channel.

As mentioned above with reference to FIG. 2b, the polling station cannot retrieve the AID of the responding polled station. It may thus assign the scheduled resource units using the indexes RU_TONE_SET_INDEX (or RA_NDP_AID) of the responding polled station (to be set in the so-called AID12 fields associated with the scheduled RUs).

A first trigger frame may be a HE Basic trigger frame and a second trigger frame may be an EHT Basic trigger frame, as in the scenario of FIG. 6.

For instance, the polling station will use a HE Basic trigger frame to schedule data RUs for polled station having responded on the first tone group (e.g. 710a) since it corresponds to the HE technology. And the polling station will also use an EHT Basic trigger frame to schedule data RUs for polled station having responded on the second tone group (e.g. 710b) since it corresponds to the EHT technology.

For instance, using the HE Basic trigger frame, RU 230-1 is assigned to the responding station of the first RU tone set (over the first tone group), RU 230-2 is assigned to the responding station of the fourth RU tone set (over the first tone group) and RU 230-3 is assigned to the responding station of the third RU tone set (over the first tone group). Using the EHT Basic trigger frame, RU 230-4 is assigned to the responding station of the first RU tone set (over the second tone group), RU 230-5 is assigned to the responding station of the second RU tone set (over the second tone group).

Any station receiving the subsequent trigger frame 720 thus determines (step S780) whether it is scheduled, based on index RA_NFRP_SET_INDEX of the responding RU tone set it has used.

Note that the station may also be directly scheduled using its own AID (for instance if the polling station mixes AIDs with RA_NDP_AID). In that case, the station preferably first searches for User Info fields having its own AID (in AID12 field) before (in case of negative result) searching for User Info fields having the RU_TONE_SET_INDEX or RA_NDP_AID.

In case of positive determination at step S780, the station uses the scheduled data RU to transmit data 231 (TB PPDU) to the polling station. This is step S682. The TB PPDU 231 contains the MAC address of the transmitting station, making it possible for the polling station to identify each transmitting station.

The polling station thus receives the TB Data PPDU 231 over the multiple scheduled RUs. It can then acknowledge (or not) the data on each RU by sending multi-STA block acknowledgment (BA) responses 240, using station AIDs retrieved from the MAC address specified in the TB Data PPDU 231. For not-yet-associated stations having responded to the RA-NFRP trigger frame 600, the polling station can still use the MAC address in the acknowledgment. This is step S666.

For instance, it may not acknowledge data over RU 230-3 as it detects a collision. No collision occurs on the other RUs, which can then be acknowledged.

This scenario of FIG. 7 of course applies to the multi-AP technology.

It may be noted that the use of the RA-NFRP trigger frame with the signaling of technologies (through bitmap 852) as exemplified in FIGS. 7, 7a and 7b advantageously provides a new universal random access scheme for the stations. Compared to the conventional 802.11ax UORA scheme, the new universal random access scheme directly includes the polling of station needs and is further compatible and scalable to other technologies than the sole 802.11ax standard.

Although the embodiments above provide subsequent trigger frames, they are not mandatory. As an example, a polling station (e.g. an AP) may use the RA-NFRP trigger frame 600 to obtain feedbacks that will not be followed by an UL transmission step. For instance, an AP as a polling station may intend to determine the number of non-associated stations for a given technology or capability (e.g. how many stations supporting a low-latency traffic service are willing to join the BSS). An appropriate Probe Response may thus follow for those stations.

Also, in the embodiments above, technologies are signaled in the (RA-)NFRP trigger frames without any additional constraint. Embodiments may contemplate restricting the NFRP trigger frame and/or some signaled technologies to some constraints. For instance, the NFRP trigger frame may further signal a type of traffic data in relation to at least one signaled technology. It means that the polling station wishes to know from the polled stations whether they need resources to transmit, using said technology, data having the specified traffic type.

An example of traffic type is the LLRS data targeted by the 802.11 be standard. Low latency reliable services, LLRSs, are services provided to a higher layer traffic stream that prioritize and deliver MSDUs (data units) within a worst-case latency budget with a given reliability/packet delivery ratio (PDR) and low jitter.

The polling station (e.g. an AP) may wish to prioritize LLRS traffic over not-LLRS traffic within its BSS, and thus may wish to request feedback of pending LLRS traffic from the other stations.

Similarly, the polling station (e.g. an AP) may wish to administrate a LLRS-targeted BSS, and thus may wish to obtain feedback from stations willing to join its managed LLRS BSS.

The traffic type may be specified for a specific signaled technology or for a group of signaled technology or for all the signaled technologies. Various signaled technologies may be constrained by different constraints (e.g. different traffic types).

Although the present invention has been described herein above with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular, the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A communication method in a wireless network, comprising the following steps at a polled station:
receiving, from a polling station, a trigger frame reserving a plurality of resource unit, RU, tone sets for responses by polled stations, the trigger frame signaling one or more 802.11 standard versions defining compliant technologies being available at the polling station,
determining at least one 802.11 standard version the polled station is compatible with from amongst the one or more signaled 802.11 standard versions, and
sending a response in relation to the compatible 802.11 standard version or versions on a selected responding RU tone set.

2. The method of claim 1, further comprising, at the polled station, receiving, using one compatible 802.11 standard version, a subsequent transmission resource from the polling station.

3. The method of claim 2, further comprising, at the polled station, consecutively to the subsequent transmission resource, receiving, using another compatible 802.11 standard version, another subsequent transmission resource from the polling station.

4. A communication method in a wireless network, comprising the following steps at a polling station:
sending, to polled stations, a trigger frame reserving a plurality of resource unit, RU, tone sets for responses by polled stations, the trigger frame signaling one or more 802.11 standard versions defining compliant technologies being available at the polling station, and
receiving, from at least one responding station on a responding RU tone set, a response in relation to at least one signaled 802.11 standard version.

5. The method of claim 4, further comprising, at the polling station, providing, using one of the signaled 802.11 standard versions, subsequent transmission resources to responding stations related to the same signaled 802.11 standard version.

6. The method of claim 5, further comprising, at the polling station, simultaneously or consecutively to the subsequent transmission resources, providing, using another signaled 802.11 standard version, other subsequent transmission resources over a distinct channel to responding stations related to the same other signaled 802.11 standard version.

7. (canceled)

8. The method of claim 27, wherein the NDP feedback report response is provided in relation to two or more signaled 802.11 standard versions.

9. (canceled)

10. The method of claim 4, wherein the one or more 802.11 standard versions are signaled in a User Info field of the trigger frame.

11. (canceled)

12. (canceled)

13. The method of claim 4, wherein the signaling of the one or more 802.11 standard versions includes setting a respective bit of a bitmap to an enabled value for each of the signaled 802.11 standard versions, where the bitmap has a plurality of bits corresponding to the plurality of 802.11 standard versions respectively.

14. The method of claim 27, wherein the signaling of the one or more 802.11 standard versions is announced, in the NFRP trigger frame, through a Feedback Type subfield set to a value different from 0 in the NFRP trigger frame.

15. The method of claim 4, wherein the trigger frame further signals a type of traffic data in relation to at least one signaled 802.11 standard version.

16. The method of claim 4, wherein the plurality of 802.11 standard versions available at the polling station includes one or more of:
High Efficiency, HE, technology compliant with 802.11ax standard version,
Extremely High Throughput, EHT, technology compliant with 802.11be standard version.

17. The method of claim 4, wherein the number of tones forming each RU tone set depends on the number of signaled 802.11 standard versions.

18. The method of claim 27, wherein each RU tone set is made of a plurality of groups of tones, each group being associated with a respective one of the signaled 802.11 standard versions.

19. The method of claim 18, wherein a NDP feedback report response related to a signaled 802.11 standard version includes conveying energy on the respective group of tones within the responding RU tone set.

20. The method of claim 27, wherein the NFRP trigger frame may specify a range of association identifiers, AIDs, designating polled stations allowed to send NDP feedback report responses on the RU tone sets.

21. The method of claim 27, wherein an association identifier, AID, field in the NFRP trigger frame may include a predefined AID value defining a random access for the polled stations to the plurality of RU tone sets.

22. A communication device comprising a processor configured for:
receiving, from a polling station, a trigger frame reserving a plurality of resource unit, RU, tone sets for responses by polled stations, the trigger frame signaling one or more 802.11 standard versions defining compliant technologies being available at the polling station,
determining at least one 802.11 standard version the polled station is compatible with from amongst the one or more signaled 802.11 standard versions, and
sending a response in relation to the compatible 802.11 standard version or versions, on a selected responding RU tone set.

23. (canceled)

24. A communication device comprising a processor configured for:
sending, to polled stations, a trigger frame reserving a plurality of resource unit, RU, tone sets for responses by polled stations, the trigger frame signaling one or more 802.11 standard versions defining compliant technologies being available at the polling station, and
receiving, from at least one responding station on a responding RU tone set, a response in relation to at least one signaled 802.11 standard version.

25. The method of claim 1, wherein the trigger frame is a null data packet, NDP, feedback report poll, NFRP, trigger frame reserving a plurality of RU tone sets for NDP feedback report responses by polled station.

26. The method of claim 1, wherein the one or more 802.11 standard versions are signaled in a User Info field of the trigger frame.

27. The method of claim 4, wherein the trigger frame is a null data packet, NDP, feedback report poll, NFRP, trigger frame reserving a plurality of RU tone sets for NDP feedback report responses by polled station.
